(19) United States
(12) Patent Application Publication
(10) Pub. No.: US 2004/0088308 A1
(43) Pub. Date: May 6, 2004

(54) Information analysing apparatus

(75) Inventors: Alexander Bailey, Berkshire (GB); Alistair William McClean, Clayton (AU)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/639,655

(22) Filed: Aug. 13, 2003

(30) Foreign Application Priority Data
Aug. 16, 2002 (GB) 0219156.7

(51) Int. Cl. G06F 7/00

(52) U.S. Cl. 707/100

(57) ABSTRACT

Information analysing apparatus is described for clustering information elements in items of information into groups of related information elements. The apparatus has an expected probability calculator (11a), a model parameter updater (11b) and an end point determiner (19) for iteratively calculating expected probabilities using first, second and third model parameters representing probability distributions for the groups, for the elements and for the items, updating the model parameters in accordance with the calculated expected probabilities and count data representing the number of occurrences of elements in each item of information until a likelihood calculated by the end point determiner meets a given criterion.

The apparatus includes a user input (5) that enables a user to input prior information relating to the relationship between at least some of the groups and at least some of the elements. At least one of the expected probability calculator (11a), the model parameter updater (11b) and the likelihood calculator is arranged to use prior data derived from the user input prior information in its calculation. In one example, the expected probability calculator uses the prior data in the calculation of the expected probabilities and in another example, the count data used by the model parameter updater and the likelihood calculator is modified in accordance with the prior data.

This invention relates to information analysing apparatus for enabling at least one of classification, indexing and retrieval of items of information such as documents.

Manual classification or indexing of items of information to facilitate retrieval or searching is very labour intensive and time consuming. For this reason, computer processing techniques have been developed that facilitate classification or indexing of items of information by automatically clustering or grouping together items of information.

One such technique is known as latent semantic analysis (LSA). This is discussed in a paper by Deerwester, Dumais, Furnas, Landauer and Harshman entitled “Indexing by Latent Semantic Analysis” published in the Journal of the American Society for Information Science 1990, volume 41 at pages 391 to 407. The approach adopted in latent semantic analysis is to provide a vector space representation of text documents and to map high dimensional count vectors such as term frequency vectors arising in this vector space to a lower dimensional representation in a so-called latent semantic space. The mapping of the document/term vectors to the latent space representatives is restricted to be linear and is based on a decomposition of the co-occurrence matrix by singular value decomposition (SVD) as discussed in the aforementioned paper by Deerwester et al. The aim of this technique is that terms having a common meaning will be roughly mapped to the same direction in the latent space.

In latent semantic analysis the coordinates of a word in the latent space constitute a linear supposition of the coordinates of the documents that contain that word. As discussed in a paper entitled “Unsupervised Learning by Probabilistic Latent Semantic Analysis” by Thomas Hofmann published in “Machine Learning” volume 42, pages 177 to 196, 2001 by Kluwer Academic Publishers, and in a paper entitled “Probabilistic Latent Semantic Indexing” by Thomas Hofmann published in the proceedings of the twenty-second Annual International SIGIR Conference on Research and Development in Information Retrieval, latent semantic analysis does not explicitly capture multiple senses of a word nor take into account that every word occurrence is typically intended to refer to only one meaning at that time.

To address these issues, the aforementioned papers by Thomas Hofmann propose a technique called “Probabilistic Latent Semantic Analysis” that associates a latent content variable with each word occurrence explicitly accounting for polysemy (that is words with multiple meanings).

Probabilistic latent semantic analysis (PLSA) is a form of a more general technique (called latent class models) for representing the relationships between observed pairs of objects (known as dyadic data). The specific application is the relationships between documents and the terms within them. There is a strong, but complex relationship between terms and documents, since the combined meaning of a document is made up of the meanings of the individual terms (ignoring grammar). For example, a document about sailing will most likely contain the terms “yacht”, “boat”, “water” etc. and a document about finance will probably contain the terms “money”, “bank”, “shares”, etc. The problem is complex not only due to the fact that many terms describe similar things (synonyms), so two documents could be strongly related but have few terms in common, but also terms can have more than one meaning (polysemy), so a sailing document may contain the word “bank” (as in river), and a financial document may contain the term “bank” (as in financial institutions) but the documents are completely unrelated.

Probabilistic latent semantic analysis allows many to many relationships between documents and terms in documents to be described in such a way that a probability of a term occurring within a document can be evaluated by use of a set of latent or hidden factors that are extracted automatically from a set of documents. These latent factors can then be used to represent the content of the documents and the meaning of terms and so can be used to form a basis for an information retrieval system. However, the factors automatically extracted by the probabilistic latent semantic analysis technique can sometimes be inconsistent in meaning covering two or more topics at once. In addition, probabilistic latent semantic analysis finds one of many possible solutions that fit the data according to random initial conditions.

In one aspect, the present invention provides information analysis apparatus that enables well defined topics to be extracted from data by effecting clustering using prior information supplied by a user or operator.

In one aspect, the present invention provides information analysing apparatus that enables a user to direct topic or factor extraction in probabilistic latent semantic analysis so that the user can decide which topics are important for a particular data set.

In an embodiment, the present invention provides information analysis apparatus that enables a user to decide which topics are important by specifying pre-allocation and/or the importance of certain data (words or terms in the case of documents) to a topic without the user having to specify all topics or factors, so enabling the user to direct the analysis process but leaving a strong element of data exploration.

In an embodiment, the present invention provides information analysing apparatus that performs word clustering using probabilistic latent semantic analysis such that factors or topics can be pre-labelled by a user or operator and then verified after the apparatus has been trained on a training set of items of information, such as a set of documents.

In an embodiment, the present invention provides information analysis apparatus that enables the process of word clustering into topics or factors to be carried out iteratively so that, after each iteration cycle, a user can check the results of the clustering process and may edit those results, for example may edit the pre-allocation of terms or words to topics, and then instruct the apparatus to repeat the word clustering process so as to further refine the process.

In an embodiment, the information analysis apparatus can be retrained on new data without significantly affecting any labelling of topics.

Embodiments of the present invention will now be described, by way of example, with reference to the accompanying drawings, in which:

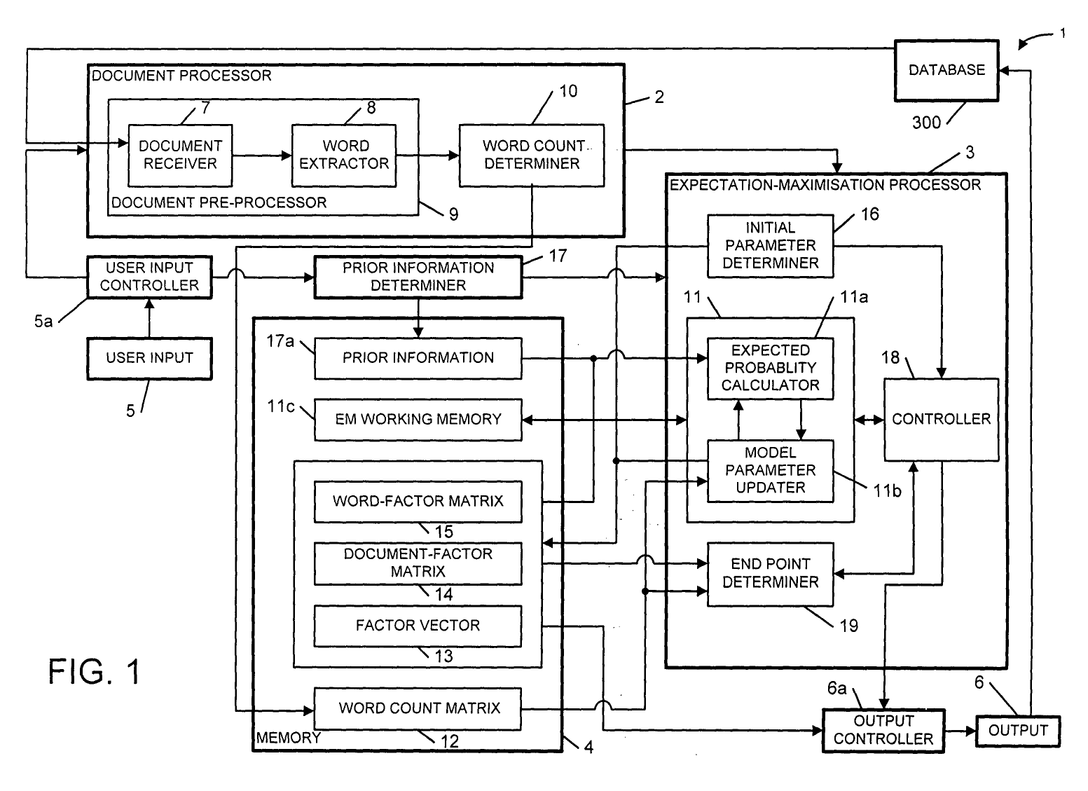

FIG. 1 shows a functional block diagram of information analysing apparatus embodying the present invention;

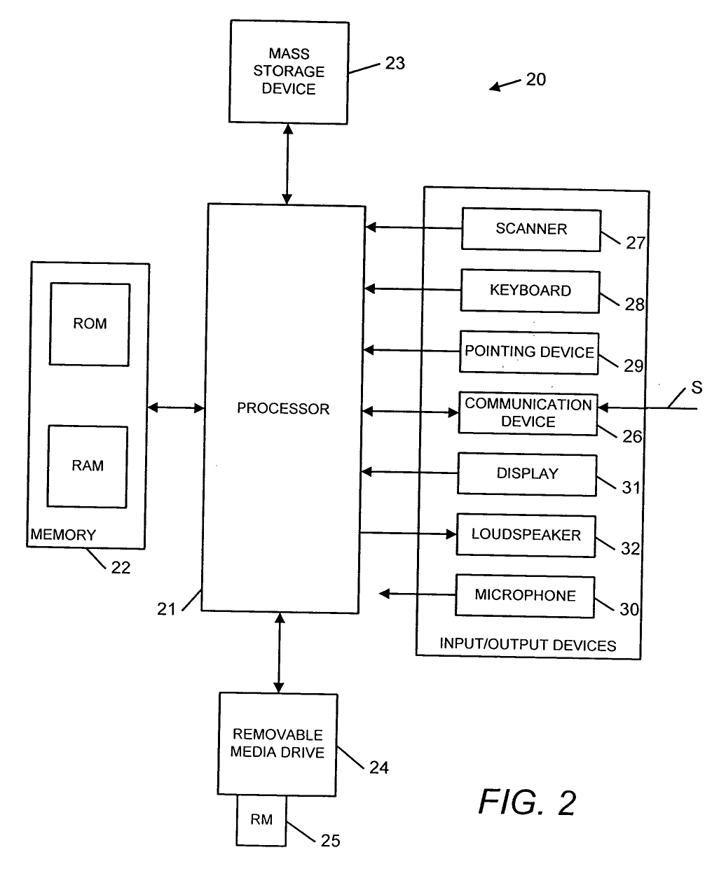

FIG. 2 shows a block diagram of computing apparatus that may be programmed by program instructions to provide the information analysing apparatus shown in FIG. 1;

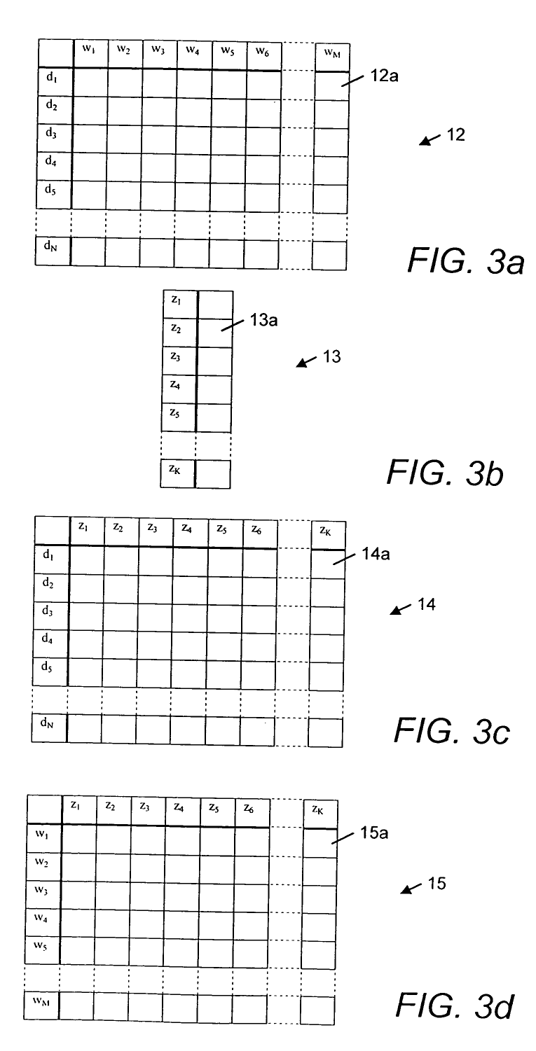

FIGS. 3a, 3b, 3c and 3d are diagrammatic representations showing the configuration of a document-word count matrix, a factor vector, a document-factor matrix and a word-factor matrix, respectively, in a memory of the information analysis apparatus shown in FIG. 1;

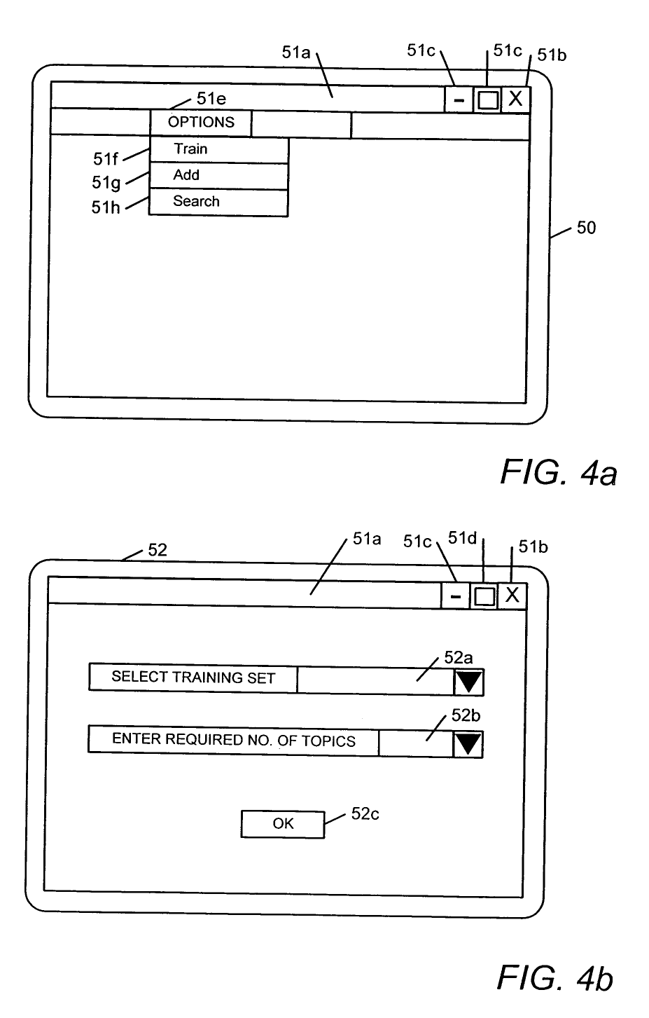

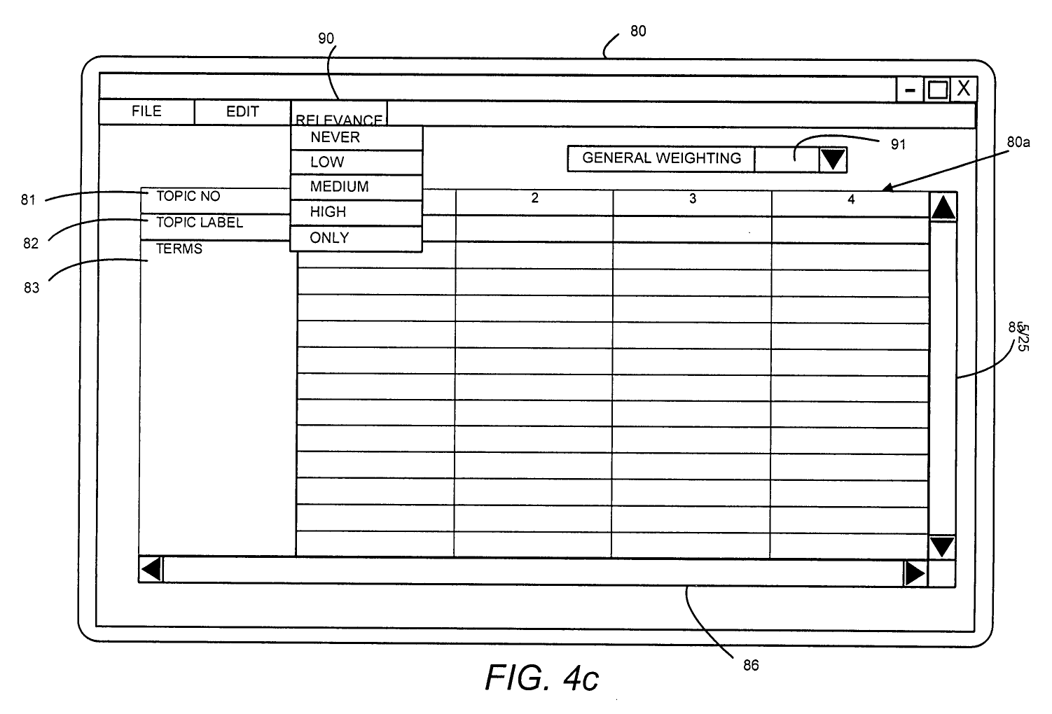

FIGS. 4a, 4b and 4c show screens that may be displayed to a user to enable analysis of items of information by the information analysis apparatus shown in FIG. 1;

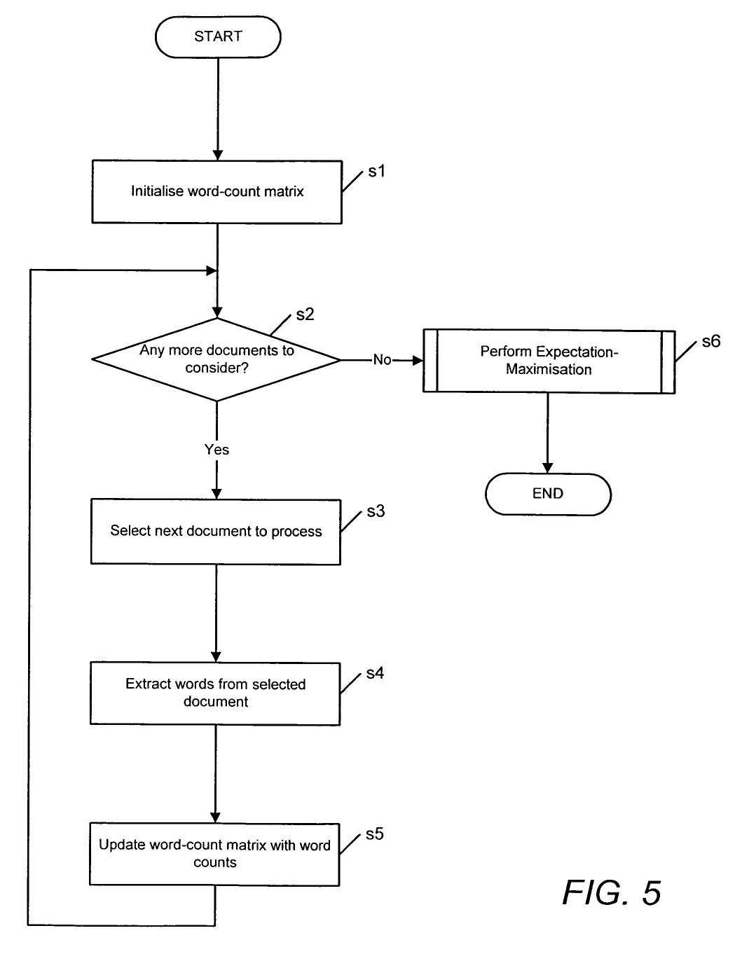

FIG. 5 shows a flow chart for illustrating operation of the information analysing apparatus shown in FIG. 1 to analyse received documents;

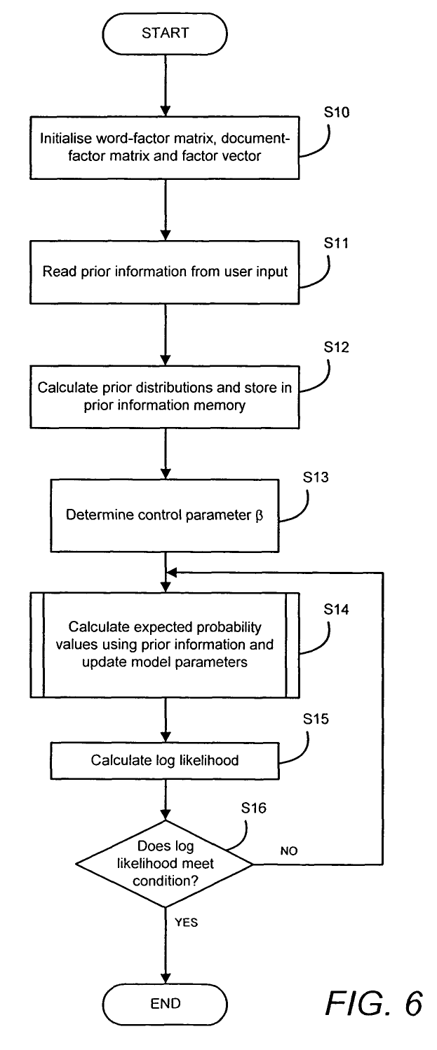

FIG. 6 shows a flow chart illustrating in greater detail a expectation-maximisation operation shown in FIG. 5;

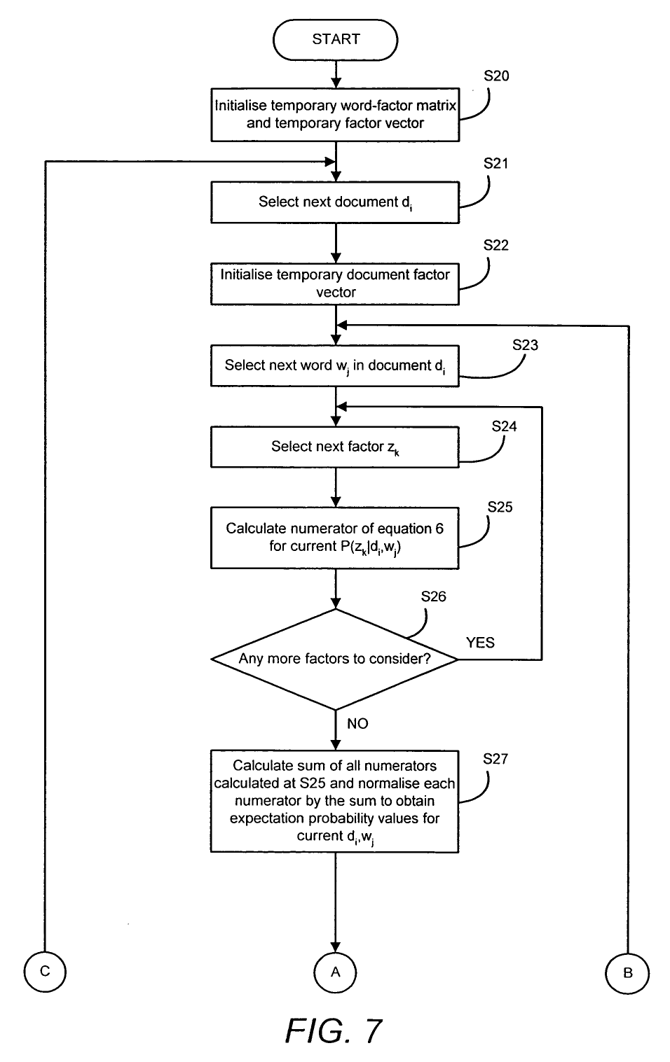

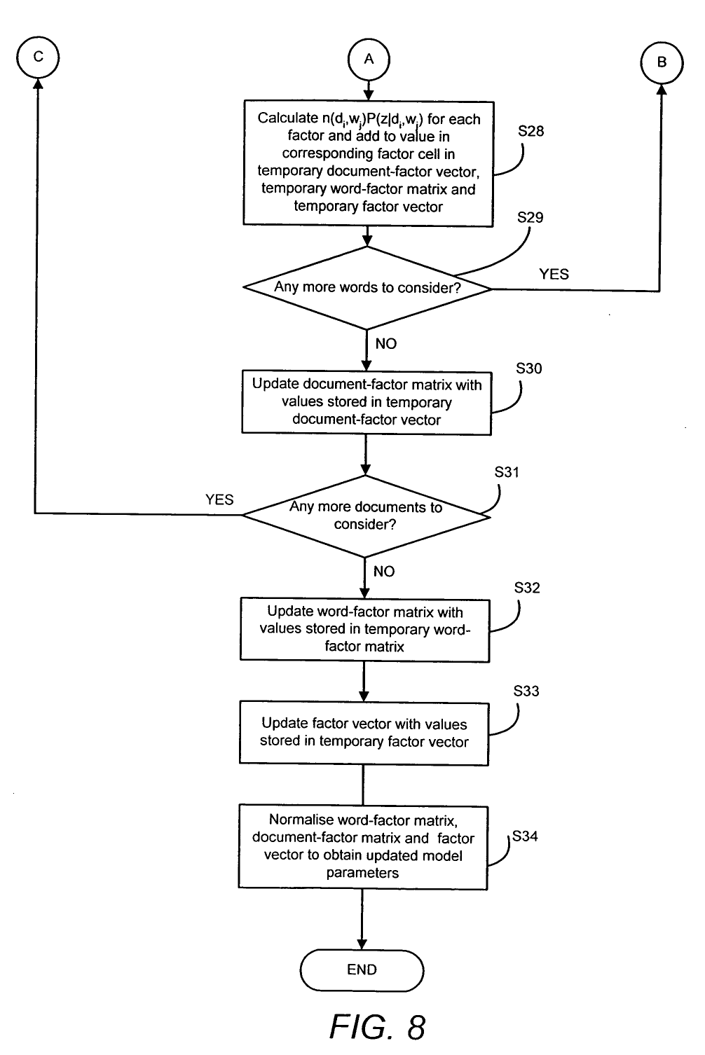

FIGS. 7 and 8 show a flow chart illustrating in greater detail the operation in FIG. 6 of calculating expected probability values and updating of model parameters;

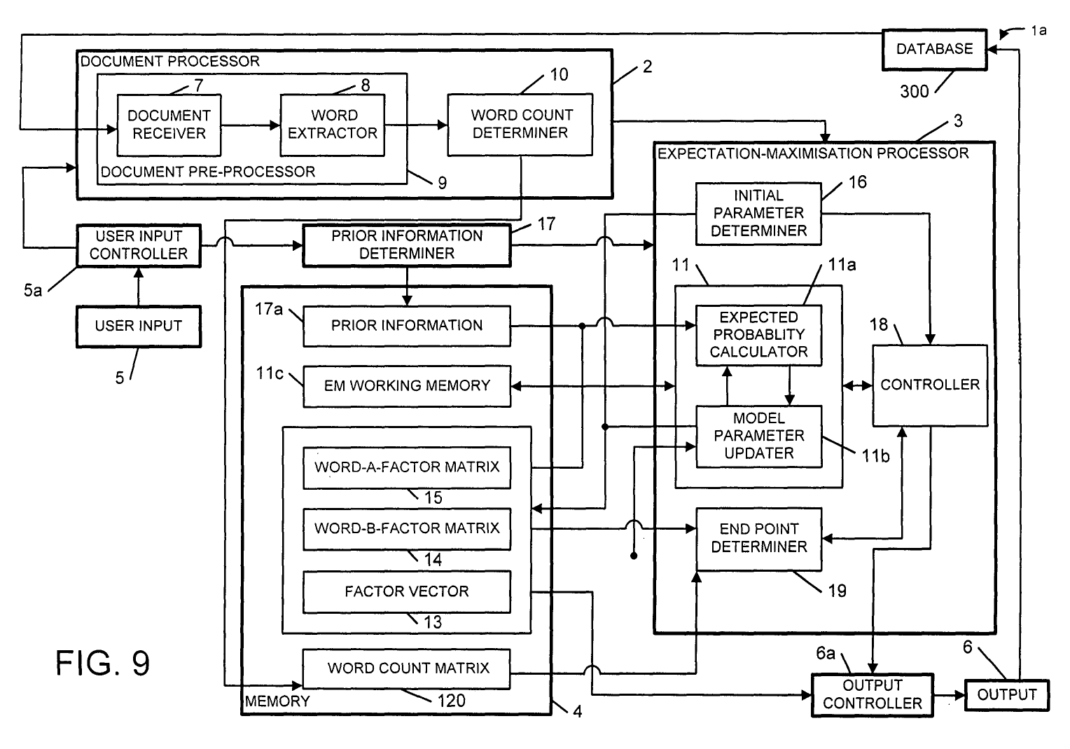

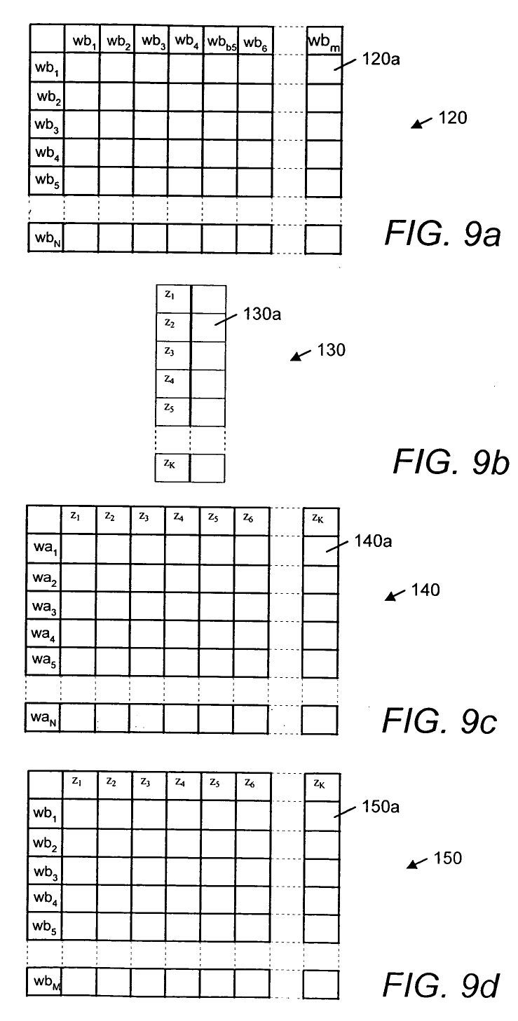

FIG. 9 shows a functional block diagram similar to FIG. 1 of another example of information analysing apparatus embodying the present invention;

FIGS. 9a, 9b, 9c and 9d are diagrammatic representations showing the configuration of word-a word-b count matrix, a factor vector, a word-a factor matrix and a word-b factor matrix, respectively, of a memory of the information analysis apparatus shown in FIG. 9;

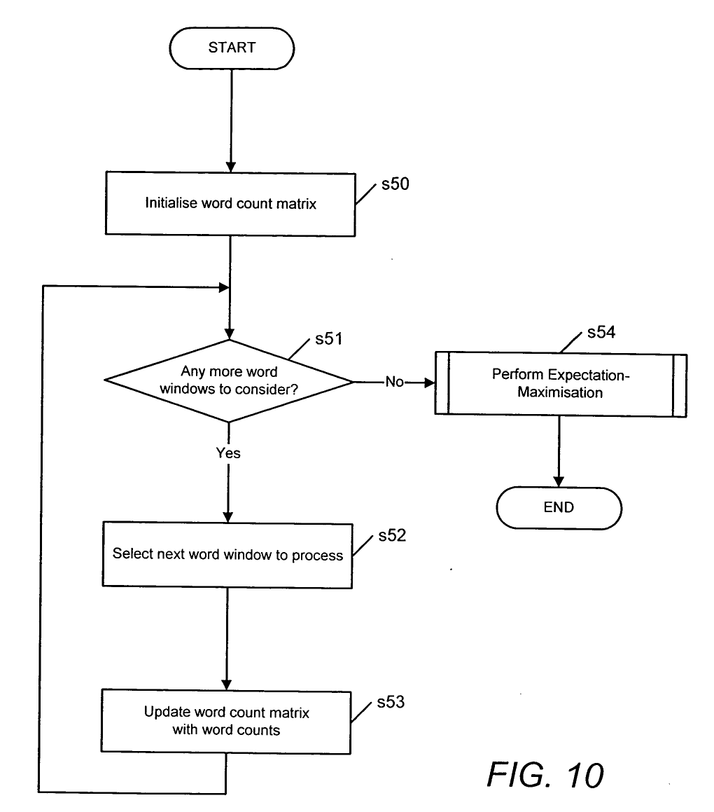

FIG. 10 shows a flow chart for illustrating operation of the information analysing apparatus shown in FIG. 9;

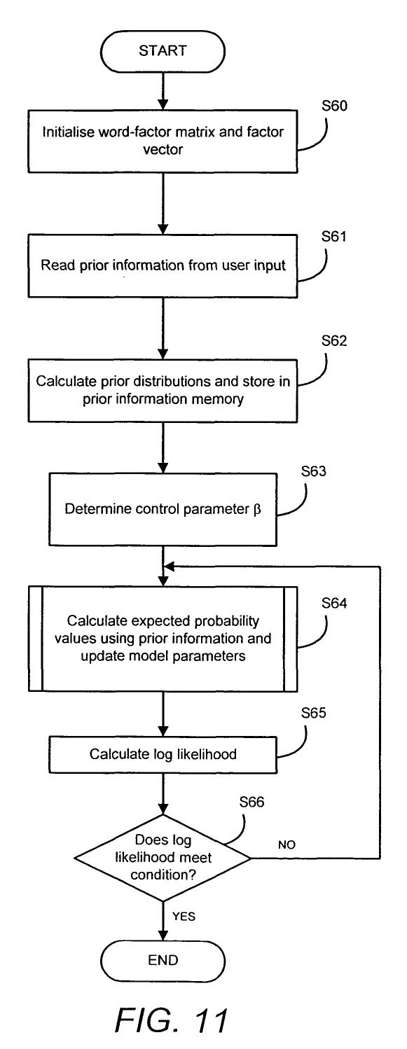

FIG. 11 shows a flow chart for illustrating an expectation-maximisation operation shown in FIG. 10 in greater detail;

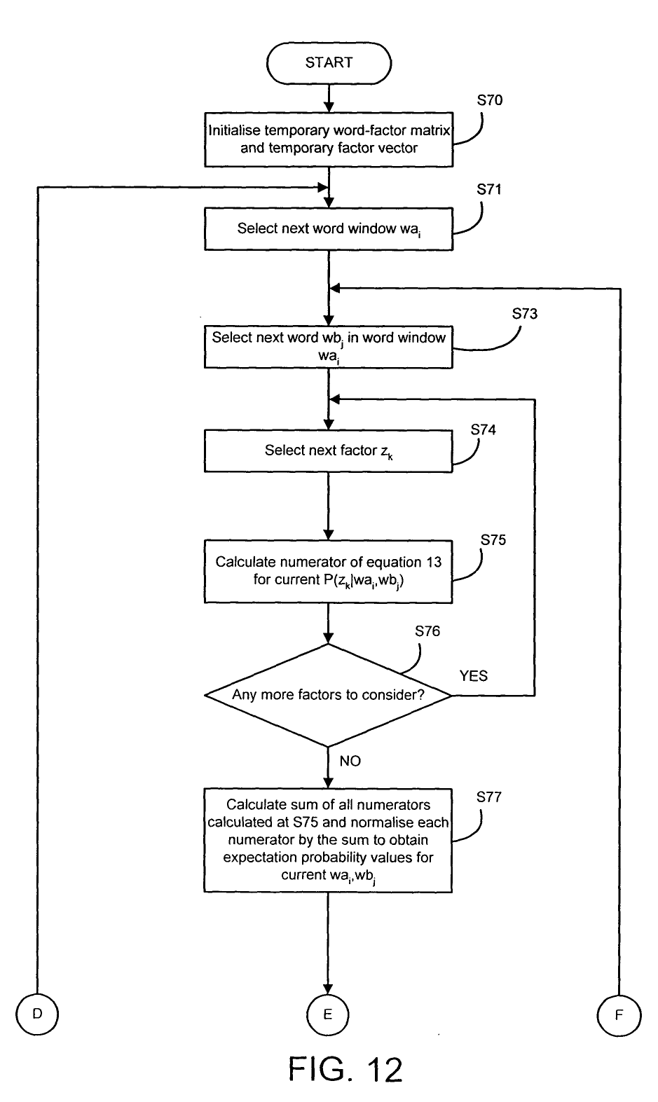

FIG. 12 shows a flow chart for illustrating in greater detail an expectation value calculation operation shown in FIG. 11;

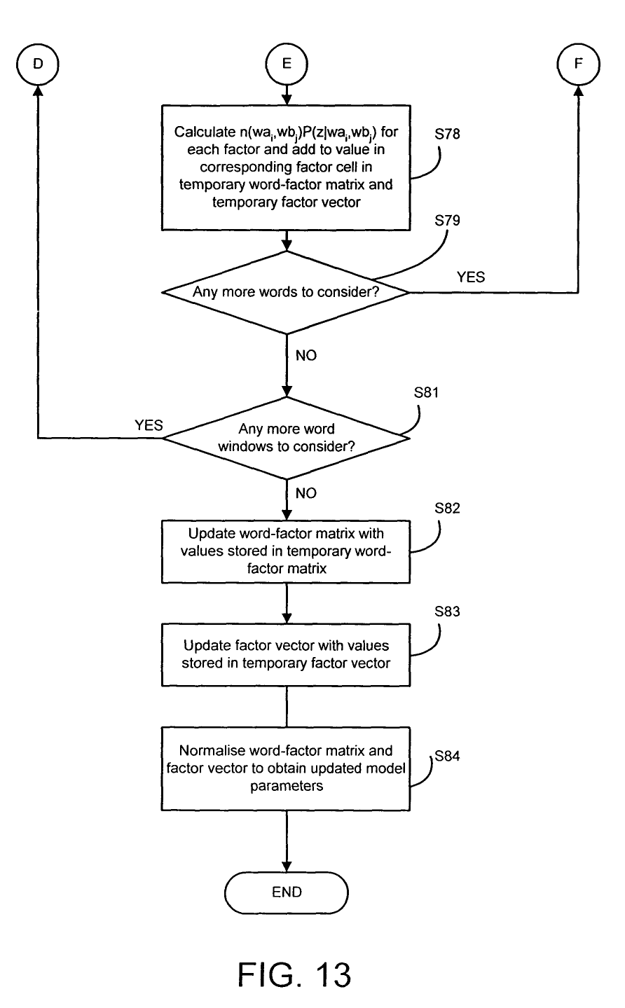

FIG. 13 shows a flow chart for illustrating in greater detail a model parameter updating operation shown in FIG. 11;

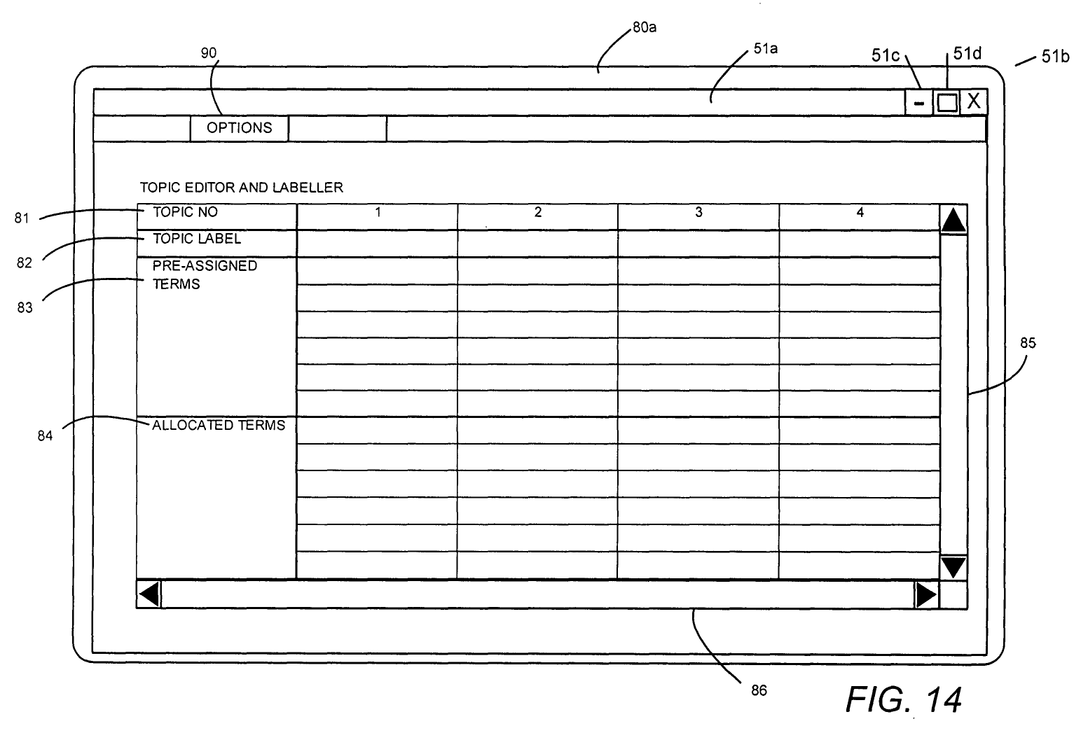

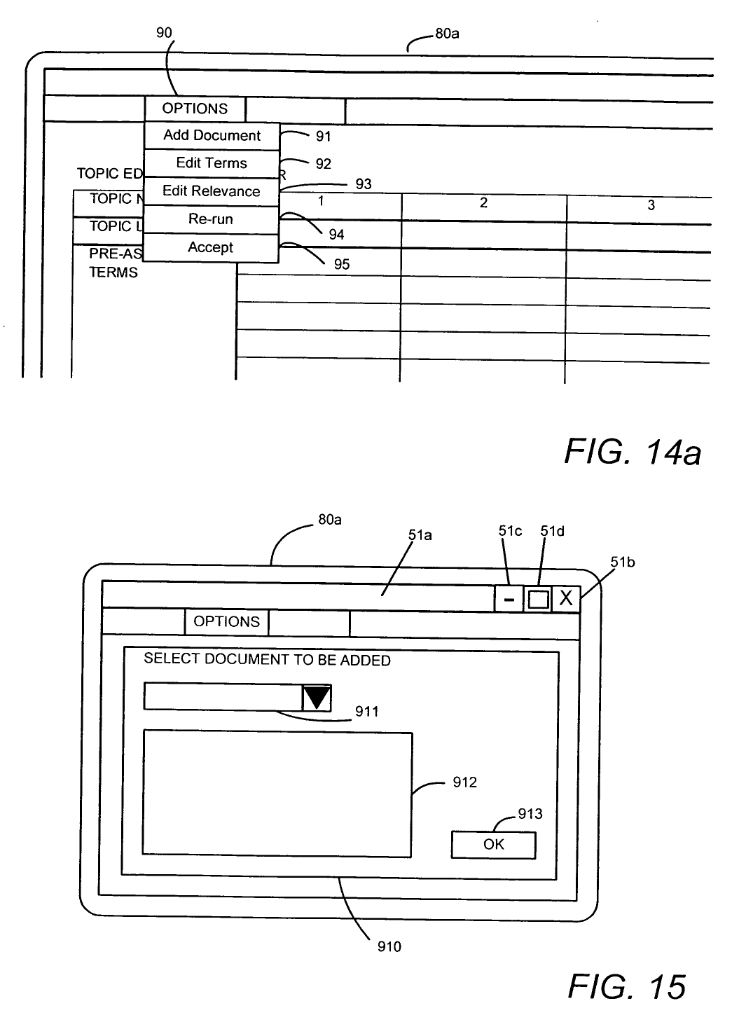

FIG. 14 shows an example of a topic editor display screen that may be displayed to a user to enable a user to edit topics;

FIG. 14a shows part of the display screen shown in FIG. 14 to illustrate options available from a drop down options menu;

FIG. 15 shows a display screen that may be displayed to a user to enable addition of a document to an information database produced by information analysis apparatus embodying the invention;

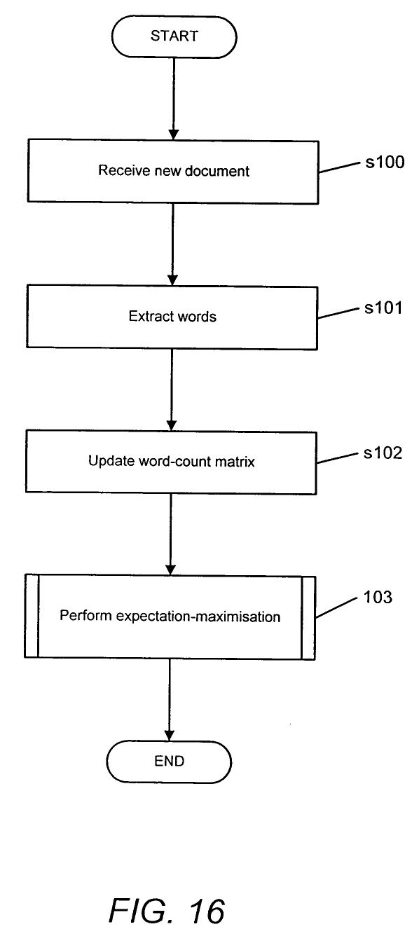

FIG. 16 shows a flow chart for illustrating incorporation of a new document into an information database produced using the information analysis application shown in FIG. 1 or FIG. 9;

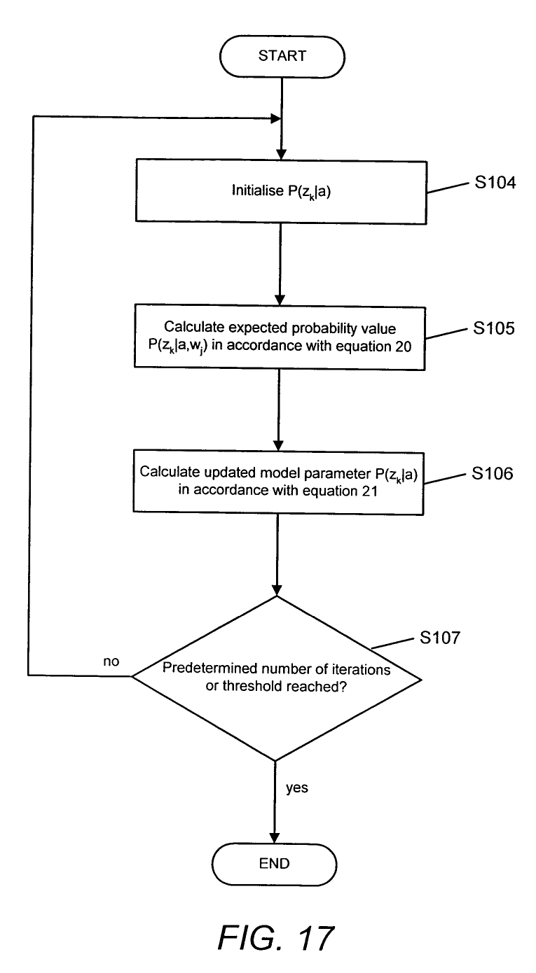

FIG. 17 shows a flow chart illustrating in greater detail an expectation-maximisation operation shown in FIG. 16;

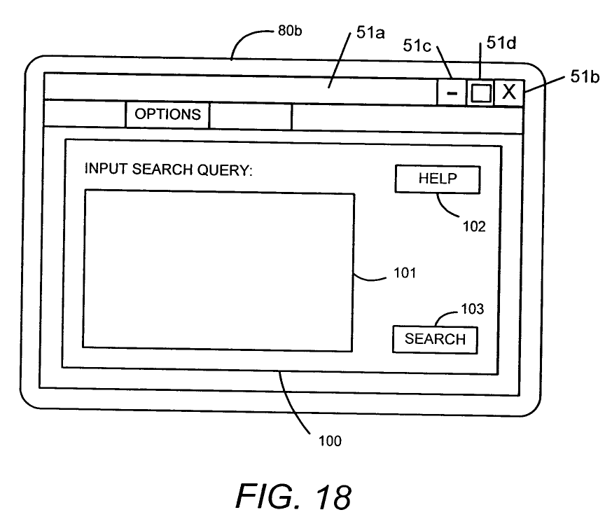

FIG. 18 shows a display screen that may be displayed to a user to enable a user to input a search query for interrogating an information database produced using the information analysing apparatus shown in FIG. 1 or FIG. 9;

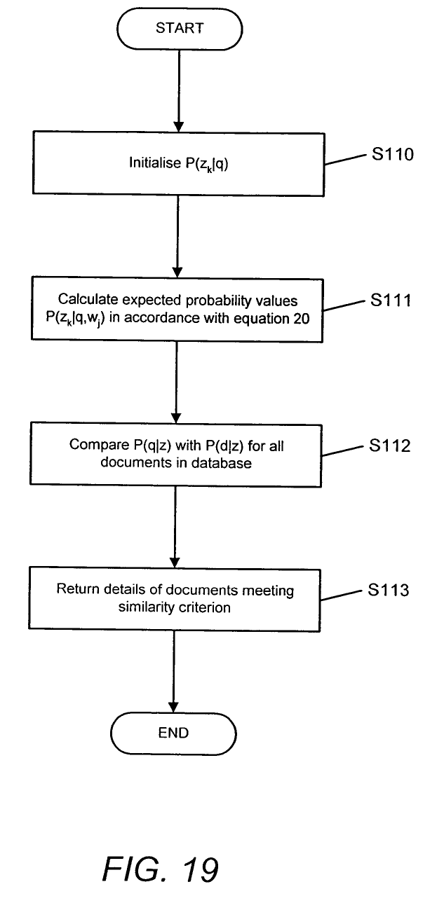

FIG. 19 shows a flow chart for illustrating operation of the information analysis apparatus shown in FIG. 1 or FIG. 9 to determine documents relevant to a query input by a user;

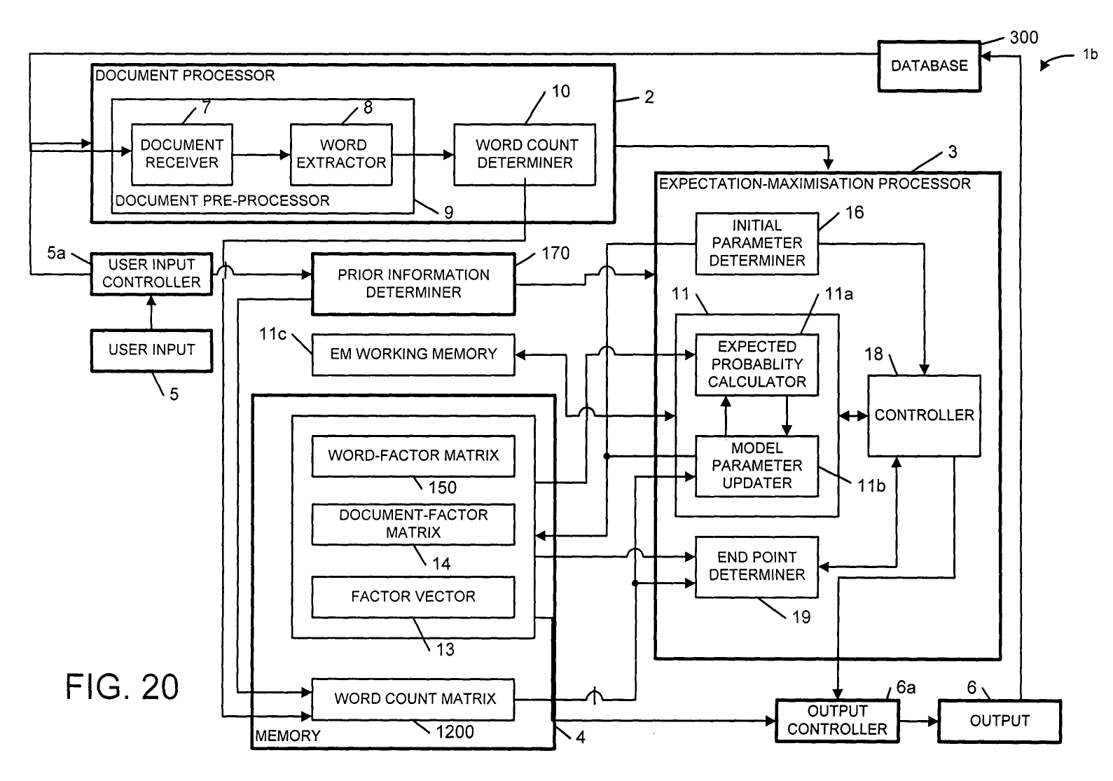

FIG. 20 shows a functional block diagram of another example of information analysing apparatus embodying the present invention;

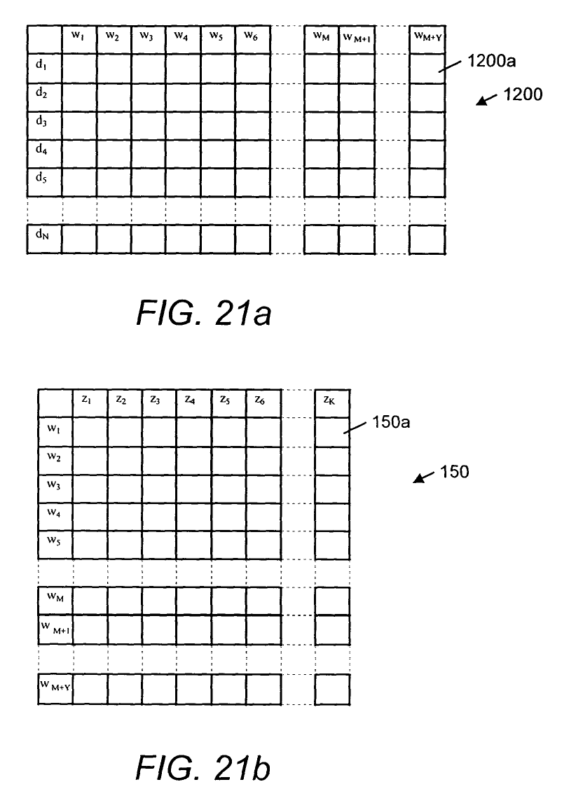

FIGS. 21a and 21b are diagrammatic representations showing the configuration of a word count matrix and a word-factor matrix, respectively, of a memory of the information analysis apparatus shown in FIG. 20;

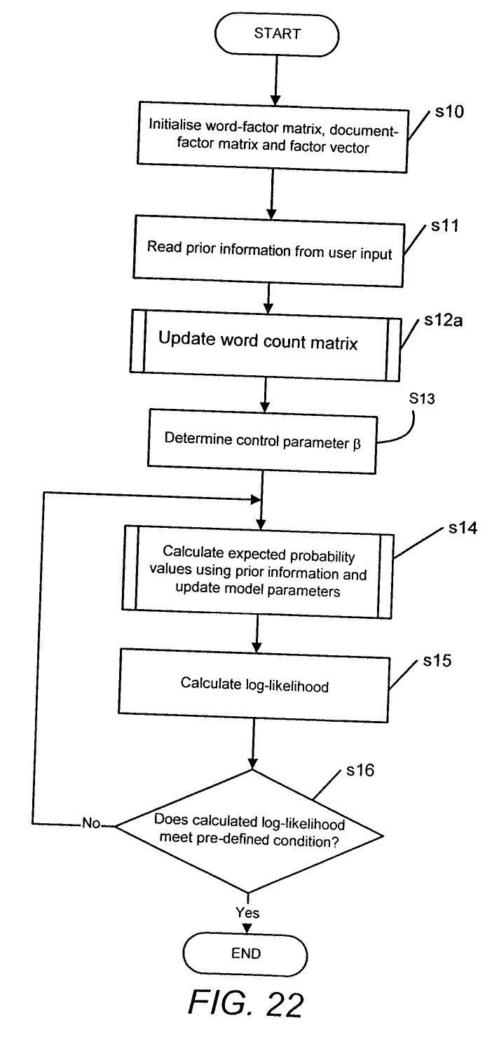

FIG. 22 shows a flow chart illustrating in greater detail a expectation-maximisation operation of the apparatus shown in FIG. 20; and

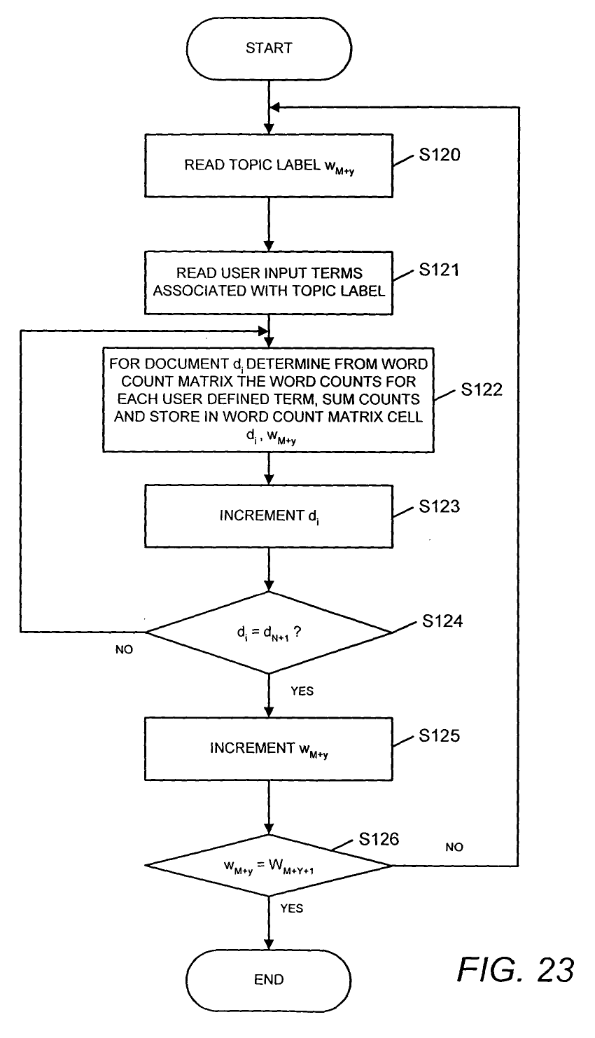

FIG. 23 shows a flow chart illustrating in greater detail an update word count matrix operation illustrated in FIG. 22.

Referring now to FIG. 1 there is shown information analysing apparatus 1 having a document processor 2 for processing documents to extract words, an expectation-maximisation processor 3 for determining topics (factors) or meanings latent within the documents, a memory 4 for storing data for use by and output by the expectation-maximisation processor 3, and a user input 5 coupled, via a user input controller 5a, to the document processor 2. The user input 5 is also coupled, via the user input controller 5a, to a prior information determiner 17 to enable a user to input prior information. The prior information determiner 17 is arranged to store prior information in a prior information store 17a in the memory 4 for access by the expectation-maximisation processor 3. The expectation-maximisation processor 3 is coupled via an output controller 6a to an output 6 for outputting the results of the analysis.

As shown in FIG. 1, the document processor 2 has a document pre-processor 9 having a document receiver 7 for receiving a document to be processed from a document database 300 and a word extractor 8 for extracting words from the received documents by identifying delimiters (such as gaps, punctuation marks and so on). The word extractor 8 is also arranged to eliminate from the words in a received document any words on a stop word list stored by the word extractor. Generally, the stop words will be words such as indefinite and definite articles and conjunctions which are necessary for the grammatical structure of the document but have no separate meaning content. The word extractor 8 may also include a word stemmer for stemming received words in known manner.

The word extractor 8 is coupled to a document word count determiner 10 of the document processor 2 which is arranged to count the number of occurrences of each word (each word stem where the word extractor includes a word stemmer) within a document and to store the resulting word counts n(d,w) for words having medium occurrence frequencies in a document-word count matrix store 12 of the memory 4. As illustrated very diagrammatically in FIG. 3a, the document-word count matrix store 12 thus has N×M elements 12a with each of the N rows representing a different one d₁, d₂, . . . d_{N} of the documents d in a set D of N documents and each of the M columns representing a different one w₁, w₂, . . . w_{M} of a set W of M unique words in the set of N documents. An element i, j of the matrix is thus arranged to store the word count n(dᵢ, wⱼ) representing the number of times the jth word appears in the ith document.

The expectation-maximisation processor 3 is arranged to carry out an iterative expectation-maximisation process and has:

an expectation-maximisation module 11 comprising an expected probability calculator 11a arranged to calculate expected probabilities P(zₖ|dᵢ,wⱼ) using prior information stored in the prior information store 17a by the prior information determiner 17 and model parameters or probabilities stored in the memory 4, and a model parameter updater 11b for updating model parameters or probabilities stored in the memory 4 in accordance with the results of a calculation carried out by the expected probability calculator 11a to provide new parameters for re-calculation of the expected probabilities by the expected probability calculator 11a;

an end point determiner 19 for determining the end point of the iterative process at which stage final values for the probabilities will be stored in the memory 4; and

an initial parameter determiner 16 for determining and storing in the memory 4 normalised randomly generated initial model parameters or probability values for use by the expected probability calculator 11a on the first iteration.

The expectation-maximisation processor 3 also has a controller 18 for controlling overall operation of the expectation-maximisation processor 3.

The manner in which the expectation maximisation processor 3 functions will now be explained.

The probability of the co-occurrence of a word and a document P(d,w) is equal to the probability of that document multiplied by the probability of that word given that document as set out in equation (1) below:

P(d,w)=P(d)P(w|d) (1)

In accordance with the principles of probabilistic latent semantic analysis described in the aforementioned papers by Thomas Hofmann, the probability of a word given a document can be decomposed into the sum over a set K of latent factors z of the probability of a word w given a factor z times the probability of a factor z given a document d as set out in equation (2) below:

$$P ( w \vert d ) = {\sum }_{z ∈ Z} P ( w \vert z ) P ( z \vert d ) \qquad ( 2 )$$

The latent factors z represent higher-level concepts that connect terms or words to documents with the latent factors representing orthogonal meanings so that each latent factor represents a unique semantic concept derived from the set of documents.

A document may be associated with many latent factors, that is a document may be made up of a combination of meanings, and words may also be associated with many latent factors (for example the meaning of a word may be a combination of different semantic concepts). Moreover, the words and documents are conditionally independent given the latent factors so that, once a document is represented as a combination of latent factors, then the individual words in that document may be discarded from the data used for the analysis, although the actual document will be retained in the database 300 to enable subsequent retrieval by a user.

In accordance with Bayes theorem, the probability of a factor z given a document d is equal to the probability a document d given a factor z times the probability of the factor z divided by the probability of the document d as set out in equation (3) below:

$$P ( z \vert d ) = \frac{P ( d \vert z ) P ( z )}{P ( d )} \qquad ( 3 )$$

This means that equation (1) can be rewritten as set out in equation (4) below:

$$P ( d , w ) = {\sum }_{z ∈ Z} P ( w \vert z ) P ( d \vert z ) P ( z ) \qquad ( 4 )$$

As set out in the aforementioned papers by Thomas Hofmann, the probability of a factor z given a document d and a word w can be decomposed as set out in equation (5) below:

$$P ( z \vert d , w ) = \frac{{P ( z ) [ P ( d \vert z ) P ( w \vert z ) ]}^{β}}{{\sum }_{{z}^{′}} {P ( {z}^{′} ) [ P ( d \vert {z}^{′} ) P ( w \vert {z}^{′} ) ]}^{β}} \qquad ( 5 )$$

where β is (as discussed in the paper entitled “Unsupervised Learning by Probabilistic Latent Semantic Analysis” by Thomas Hofmann) a parameter which, by analogy to physical systems, is known as an inverse computational temperature and is used to avoid over-fitting.

The expected probability calculator 11a is arranged to calculate the probability of factor z given document d and word w by using the prior information determined by the prior information determiner 17 in accordance with data input by a user using the user input 5 to specify initial values for the probability of a factor z given a document d and the probability of a factor z given a word w for a particular factor zₖ, document dᵢ and word wⱼ. Accordingly, the expected probability calculator 11a is configured to compute equation (6) below:

$$\begin{matrix}P ( {z}_{k} \vert {d}_{i} , {w}_{j} ) = \frac{\hat{P} ( {z}_{k} \vert {d}_{i} ) \hat{P} ( {z}_{k} \vert {w}_{j} ) {P ( {z}_{k} ) [ P ( {d}_{i} \vert {z}_{k} ) P ( {w}_{j} \vert {z}_{k} ) ]}^{β}}{{\sum }_{{k}^{′} = 1}^{K} \hat{P} ( {z}_{{k}^{′}} \vert {d}_{i} ) \hat{P} ( {z}_{{k}^{′}} \vert {w}_{j} ) {P ( {z}_{{k}^{′}} ) [ P ( {d}_{i} \vert {z}_{{k}^{′}} ) P ( {w}_{j} \vert {z}_{{k}^{′}} ) ]}^{β}} & ( 6 ) \\ where & \\ \hat{P} ( {z}_{k} \vert {w}_{j} ) = \frac{{ⅇ}^{γ {u}_{jk}}}{{\sum }_{{k}^{′} = 1}^{K} {ⅇ}^{γ {u}_{{jk}^{′}}}} & ( 7 a )\end{matrix}$$

represents prior information provided by the prior information determiner 17 for the probability of the factor zₖ given the word wⱼ with γ being a value determined in accordance with information input by the user indicating the overall importance of the prior information and uⱼₖ being a value determined in accordance with information input by the user indicating the importance of the particular term or word; and

$$\hat{P} ( {z}_{k} \vert {d}_{i} ) = \frac{λ {v}_{ik}}{{\sum }_{{k}^{′} = 1}^{K} {ⅇ}^{λ {v}_{{ik}^{′}}}} \qquad ( 7 b )$$

represents prior information provided by the prior information determiner 17 for the probability of the factor zₖ given the document dᵢ with λ being a value determined by information input by the user indicating the overall importance of the prior information and vᵢₖ being a value determined by information input by the user indicating the importance of the particular document.

In this arrangement, the user input 5 enables the user to determine prior information regarding the above mentioned probabilities for a relatively small number of the factors and the prior information determiner 17 is arranged to provide the distributions set out in equations (7a) and (7b) so that they are uniform except for the terms defined by the prior information input by the user using the user input 5. Accordingly, the prior information can be specified in a simple data structure.

The memory 4 has a number of stores, in addition to the word count matrix store 12, for storing data for use by and for output by the expectation-maximisation processor 3.

FIGS. 3b to 3d show very diagrammatically the configuration of a factor-vector store 13, a document-factor matrix store 14 and a word-factor matrix store 15. As shown in FIG. 3b, the factor vector store 13 is configured to store probability values P(z) for factors z₁, z₂, . . . z_{K} of the set of K latent or hidden factors to be determined, such that the kth element 13a stores a value representing the factor zₖ.

As shown in FIG. 3c, the document-factor matrix store 14 is arranged to store a document-factor matrix having N rows each representing a different one of the documents dᵢ in the set of N documents and K columns each representing a different one of the factors zₖ in the set K of latent factors. The document-factor matrix store 14 thus provides N×K elements 14a each for storing a corresponding value P(dᵢ|zₖ) representing the probability of a particular document dᵢ given a particular factor zₖ.

As represented in FIG. 3d, the word-factor matrix store 15 is arranged to store a word-factor matrix having M rows each representing a different one of the words wⱼ in the set of M unique medium frequency words in the set of N documents and K columns each representing a different one of the factors zₖ in the set K of latent factors. The word-factor matrix store 15 thus provides M×K elements 15a each for storing a corresponding value P(wⱼ|zₖ) representing the probability of a particular word wⱼ given a particular factor zₖ.

A set of documents will normally consist of a number of documents in the range of approximately 10,000 to 100,000 documents and there will be approximately 10,000 unique words having medium frequency of occurrence identified by the word count determiner 10, so that the word factor matrix and the document factor matrix will each have 10000 rows. In each case, however, the number of columns will be equivalent to the number of factors or topics which may be, typically, in the range from 50 to 300.

The prior information store 17a consists of two matrices having configurations similar to the document-factor and word-factor matrices, although in this case the data stored in each element will of course be the prior information determined by the prior information determiner 17 for the corresponding document-factor or word-factor combination in accordance with equation (7a) or (7b).

It will, of course, be appreciated that the rows and columns in the matrices may be transposed.

The expectation-maximisation module 11 is controlled by the controller 18 to carry out an expectation-maximisation process once the prior information determiner has advised the controller 18 that the prior information has been stored in the prior information store 17a and the initial parameter determiner 16 has advised the controller 18 that the randomly generated normalised initial parameters for the model parameters P(zₖ), P(dᵢ|zₖ) and P(wⱼ|zₖ) have been stored in the factor vector matrix store 13, document factor matrix store 14 and word factor matrix store 15, respectively.

The expected probability calculator 11a is configured in this example to calculate expected probability values P(zₖ|dᵢ,wⱼ) for all factors for each document-word combination dᵢwⱼ in turn in accordance with equation (6) using the model parameters P(zₖ), P(dᵢ|zₖ) and P(wⱼ|zₖ) read from the factor vector matrix store 13, document factor matrix store 14 and word factor matrix store 15, respectively, and prior information read from the prior information store 17a and to supply the expected probability values for a particular document-word combination dᵢwⱼ to the model parameter updater 11b once calculated.

The model parameter updater 11b is configured to receive expected probability values from the expected probability calculator 11a, to read word counts or frequencies from the word-count matrix store 12 and then to calculate for all factors zₖ and that document-word combination dᵢwⱼ the probability of wⱼ given zₖ, P(wⱼ|zₖ), the probability of dᵢ given zₖ, P(dᵢ|zₖ), and the probability of zₖ, P(zₖ) in accordance with equations (8), (9) and (10) below:

$$\begin{matrix}P ( {w}_{j} \vert {z}_{k} ) = \frac{{\sum }_{i = 1}^{N} n ( {d}_{i} , {w}_{j} ) P ( {z}_{k} \vert {d}_{i} , {w}_{j} )}{{\sum }_{i = 1}^{N} {\sum }_{{j}^{′} = 1}^{M} n ( {d}_{i} , {w}_{{j}^{′}} ) P ( {z}_{k} \vert {d}_{i} , {w}_{{j}^{′}} )} & ( 8 ) \\ P ( {d}_{i} \vert {z}_{k} ) = \frac{{\sum }_{j = 1}^{M} n ( {d}_{i} , {w}_{j} ) P ( {z}_{k} \vert {d}_{i} , {w}_{j} )}{{\sum }_{{i}^{′} = 1}^{N} {\sum }_{j = 1}^{M} n ( {d}_{{i}^{′}} , {w}_{j} ) P ( {z}_{k} \vert {d}_{{i}^{′}} , {w}_{j} )} & ( 9 ) \\ P ( {z}_{k} ) = \frac{1}{R} {\sum }_{i = 1}^{N} {\sum }_{j = 1}^{M} n ( {d}_{i} , {w}_{j} ) P ( {z}_{k} \vert {d}_{i} , {w}_{j} ) & ( 10 )\end{matrix}$$

where R is given by equation (11) below:

$$R ≡ {\sum }_{i = 1}^{N} {\sum }_{j = 1}^{M} n ( {d}_{i} , {w}_{j} ) \qquad ( 11 )$$

and n(dᵢ,wⱼ) is the number of occurrences or the count for a given word wⱼ in a document dᵢ, that is the data stored in the corresponding element 12a of the word count matrix store 12.

The model parameter updater 11b is coupled to the factor vector store 13, document factor matrix store 14 and word factor matrix store 15 and is arranged to update the probabilities or model parameters P(zₖ), P(dᵢ|zₖ) and P(wⱼ|zₖ) stored in those stores in accordance with the results of calculating equations (8), (9) and (10) so that these updated model parameters can be used by the expected probability calculator 11a in the next iteration.

The model parameter updater 11b is arranged to advise the controller 18 when all the model parameters have been updated. The controller 18 is configured then to cause the end point determiner 19 to carry out an end point determination. The end point determiner 19 is configured, under the control of the controller 18, to read the updated model parameters from the word-factor matrix store 15, the document-factor matrix store 14 and the factor vector store 13, to read the word counts n(d,w) from the word count matrix store 12, to calculate a log likelihood L in accordance with equation (12) below:

$$L = {\sum }_{i = 1}^{N} {\sum }_{j = 1}^{M} n ( {d}_{i} , {w}_{j} ) log P ( {d}_{i} , {w}_{j} ) \qquad ( 12 )$$

and to advise the controller 18 whether or not the log likelihood value L has reached a predetermined end point, for example a maximum value or the point at which the improvement in the log likelihood value L reaches a threshold. As another possibility, the threshold may be determined as a preset maximum number of iterations.

The controller 18 is arranged to instruct the expected probability calculator 11a and model parameter updater 11b to carry out further iterations (with the expected probability calculator 11a using the new updated model parameters provided by the model parameter updater 11b and stored in the corresponding stores in the memory 4 each time the calculation is carried out), until the end point determiner 19 advises the controller 18 that the log likelihood value L has reached the end point.

The expected probability calculator 11a, model parameter updater 11b and end point determiner 19 are thus configured, under the control of the controller 18, to implement an expectation-maximisation (EM) algorithm to determine the model parameters P(wⱼ|zₖ), P(dᵢ|zₖ) and P(zₖ) for which the log likelihood L is a maximum so that, at the end of the expectation-maximisation process, the terms or words in the document set will have been clustered in accordance with the factors z using the prior information specified by the user. At this point, the controller 18 will instruct the output controller 6a to cause the output 6 to output analysed data to the user as will be described below.

FIG. 2 shows a schematic block diagram of computing apparatus 20 that may be programmed by program instructions to provide the information analysing apparatus 1 shown in FIG. 1. As shown in FIG. 2, the computing apparatus comprises a processor 21 having an associated working memory 22 which will generally comprise random access memory (RAM) plus possibly also some read only memory (ROM). The computing apparatus also has a mass storage device 23 such as a hard disk drive (HDD) and a removable medium drive (RMD) 24 for receiving a removable medium (RM) 25 such as a floppy disk, CD ROM, DVD or the like.

The computing apparatus also includes input/output devices including, as shown, a keyboard 28, a pointing device 29 such as a mouse and possibly also a microphone 30 for enabling input of commands and data by a user where the computing apparatus is programmed with speech recognition software. The user interface device also includes a display 31 and possibly also a loudspeaker 32 for outputting data to the user.

In this example, the computing apparatus also has a communications device 26 such as a modem for enabling the computing apparatus 20 to communicate with other computing apparatus over a network such as a local area network (LAN), wide area network (WAN), the Internet or an Intranet and a scanner 27 for enabling hard copy or paper documents to be electronically scanned and converted using optical characteristic recognition (OCR) software stored in the mass storage device 23 as electronic text data. Data may also be output to a remote user via the communications device 26 over a network.

The computing apparatus 20 may be programmed to provide the information analysing apparatus 1 shown in FIG. 1 by any one or more of the following ways:

program instructions downloaded from a removable medium 25;

program instructions stored in the mass storage device 23;

program instructions stored in a non-volatile portion of the memory 22; and

program instructions supplied as a signal S via the communications device 26 from other computing apparatus.

The user input 5 shown in FIG. 1 may include any one or more of the keyboard 28, pointing device 29, microphone 30 and communications device 26 while the output 6 shown in FIG. 1 may include any one or more of the display 31, loudspeaker 32 and communications device 26. The document database 300 in FIG. 1 may be arranged to store electronic document data received from at least one of the mass storage device 23, a removable medium 25, the communications device 26 and the scanner 27 with, in the latter case, the scanned data being subject to OCR processing before supply to the document database 300.

Operation of the information analysing apparatus shown in FIG. 1 will now be described with the aid of FIGS. 4a to 8. In this example, the user interacts with the apparatus via windows style format display screens displayed on the display 31. FIGS. 4a, 4b and 4c show very diagrammatic representations of such screens having the usual title bar 51a, close, minimise and maximise buttons 51b, 51c and 51d. FIGS. 5 to 8 show flow charts for illustrating operations carried out by the information analysing apparatus 1 during a training procedure. For the purpose of this explanation, it is assumed that any documents to be analysed are already in or have already been converted to electronic form and are stored in the document database 300.

Initially the user input controller 5a of the information analysis apparatus 1 causes the display 31 to display to the user a start screen which enables the user to select from a number of options. FIG. 4a illustrates very diagrammatically one example of such a start screen 50 in which a drop down menu 51e entitled “options” has been selected showing as the available options “train” 51f, “add” 51g and “search” 51h.

When the user selects the “train” 51f option, that is the user elects to instruct the apparatus to conduct analysis on a training set of documents, the user input controller 5a causes the display 31 to display to the user a screen such as the screen 52 shown in FIG. 4b which provides a training set selection drop down menu 52a that enables a user to select a training set of documents from the database 300 by file name or names and a number of topics drop down menu 52b that enables a user to select the number of topics into which they which the documents to be clustered. Typically, the training set will consist of in the region of 10000 to 100000 documents and the user will be allowed to select from about 50 to about 300 topics.

Once the user is satisfied with the training set selection and number of topics, then the user selects an “OK” button 52c. In response, the user input controller 5a causes the display to display a prior information input interface display screen. FIG. 4c shows an example of such a display screen 80. In this example, the user is allowed to assign terms but not documents to the topics (that is the distribution of Equation (7b) is set as uniform) and so the display screen 80 provides the user with facilities to assign terms or words but not documents to topics. Thus, the screen 80 displays a table 80a consisting of three rows 81, 82 and 83 identified in the first cells of the rows as topic number, topic label and topic terms rows. The table includes a column for each topic number for which the user can specify prior information. The user may be allowed to specify prior information for, for example 20, 30 or more topics. Accordingly, the table is displayed with scroll bars 85 and 86 that enable the user to scroll to different parts of the table in known manner. As shown, four topics columns are visible and are labelled for convenience as topic numbers 1, 2, 3 and 4.

The user then uses his knowledge of the general content of the documents of the training set to input into cells in the topic columns using the keyboard 28 terms or words that he considers should appear in documents associated with that particular topic. The user may also at this stage input into the topic label cells corresponding topic labels for each of the topic for which terms the user is assigning terms.

As an example, the user may select “computing”, “the environment”, “conflict” and “financial markets” as the topic labels for topic numbers 1, 2, 3, and 4 respectively, and may preassign the following topic terms:

topic number 1: computer, software, hardware

topic number 2: environment, forest, species, animals

topic number 3: war, conflict, invasion, military

topic number 4: stock, NYSE, shares, bonds.

In order to enable the user to select the relevance of terms (that is the values uⱼₖ in this case), the display screen shown in FIG. 4c has a drop down menu 90 labelled “relevance” which, when selected as shown in FIG. 4c, gives the user a list of options to select the relevance for a currently highlighted term input by the user. As shown, the available degrees of relevance are:

NEVER meaning that the term must not appear in the topic and so the probability of that term and factor in equation (7a) should be set to zero;

LOW meaning that the probability of that term and factor in equation (7a) should be set to a predetermined low value;

MEDIUM meaning that the probability of that term and factor in equation (7a) should be set to a predetermined medium value;

HIGH meaning that the probability of that term and factor in equation (7a) should be set to a predetermined high value;

ONLY meaning that the probability of that term and factor in equation (7a) in any of the other topics for which terms are being assigned should be set to zero

The display screen 80 also provides a general relevance drop down menu 91 that enables a user to determine how significant the prior information is, that is to determine γ.

Once the user is satisfied with the pre-assigned terms and his selection of their relevance and the general relevance of the pre-assigned terms, then the user can instruct the apparatus 1 to commence analysing the selected training set on the basis of this prior information.

FIG. 5 shows an overall flow chart for illustrating this operation for the information analysing apparatus shown in FIG. 1.

At S1 in FIG. 5, the document word count determiner 10 initialises the word count matrix in the document word count matrix store 12 so that all values are set to zero. Then at S2, the document receiver 7 determines whether there is a document to consider and, if so, at S3 selects the next document to be processed from the database 300 and forwards it to the word extractor 8 which, at S4 in FIG. 5, extracts words from the selected document as described above, eliminating any stop words in its stop word list and carrying out any stemming. The document pre-processor 9 then forwards the resultant word list for that document to the document word count determiner 10 and, at S5 in FIG. 5, the document word count determiner 10 determines, for that document the number of occurrences of words in the document, selects the unique words wⱼ having medium frequencies of occurrence and populates the corresponding column of the document word count matrix in the document word count matrix store 12 with the corresponding word frequencies or counts, that is the word count n(dᵢ,wⱼ). Thus, words that occur very frequently and thus are probably common words are omitted as are words that occur very infrequently and may be, for example, mis-spellings.

The document pre-processor 9 and document word count determiner 10 repeat operations S2 to S5 until each of the training documents d₁ to d_{N} has been considered, at which point the document word count matrix store 12 stores a matrix in which the word count or number of occurrences of each of words w₁ to w_{M} in each of documents d₁ to d_{N} has been stored.

Once the document word count has been completed for the training set of documents, that is the answer at S2 is no, then the document processor 2 advises the expectation-maximisation processor 3 and the controller 18 then commences the expectation-maximisation operation at S6 in FIG. 5 causing that the expected probability calculator 11a and model parameter updater 11b iteratively to calculate and update the model parameters or probabilities until the end point determiner 19 determines that the log likelihood value L has reached a maximum or best value (that is there is no significant improvement from the last iteration) or a preset maximum number of iterations have occurred. At this point, the controller 18 determines that the clustering has been completed, that is a probability of each of the words w₁ to w_{M} being associated with each of the topics z₁ to zₖ has been determined and causes the output controller 6a to provide to the output 6 analysed document database data associating each document in t0he training set with one or more topics and each topic with a set of terms determined by the clustering process.

The expectation-maximisation operation of S6 in FIG. 5 will now be described in greater detail with reference to FIGS. 6 to 8.

Thus, at S10 in FIG. 6 the initial parameter determiner 16 initialises the word-factor matrix store 15, document-factor matrix store 14 and factor vector store 13 by determining randomly generated normalised initial model parameters or probabilities and storing these in the corresponding elements in the factor vector store 13, in the document-factor matrix store 14 and in the word-factor matrix store 15, that is initial values for the probabilities P(zₖ), P(dᵢ|zₖ) and P(wⱼ|zₖ).

The prior information determiner 17 then, at S11 in FIG. 6, reads the prior information input via the user input 5 as described above with reference to FIG. 4c and at S12 calculates the prior information distribution in accordance with equation (7a) and stores it in the prior information store 17a. In this case, a uniform A distribution is assumed for \hat{P}(zₖ|dᵢ) (equation (7b)) and accordingly the expected probability calculator 11a ignores or omits this term when calculating equation (6).

The prior information determiner 17 then advises the controller 18 that the prior information is available in the prior information store 17a which then instructs the expectation-maximisation module 11 to commence the expectation-maximisation procedure.

At S13, the expectation-maximisation module 11 determines the control parameter β which, as set out in the paper by Thomas Hofmann entitled “Unsupervised Learning by Probabilistic Latent Semantic Analysis”, is known as the inverse computational temperature. The expectation-maximisation module 11 may determine the control parameter β by reading a value preset in memory. As another possibility, as discussed in Section 3.6 of the aforementioned paper by Thomas Hofmann, the value for the control parameter β may be determined by using an inverse annealing strategy in which the expectation-maximisation process to be described below is carried out for a number of iterations on a sub-set of the documents and the value of the control parameter β decreased with each iteration until no further improvement in the log likelihood L of the sub-set is achieved at which stage the final value for β is obtained.

Then at S14 the expected probability calculator 11a calculates the expected probability values in accordance with equation (6) using the prior information stored in the prior information store 17a and the initial model parameters or probabilities stored in the factor vector store 13, document factor matrix store 14 and the word factor matrix store 15 and the model parameter updater 11b updates the model parameters in accordance with equations (8), (9) and (10) and stores the updated model parameters in the appropriate store 13, 14 or 15.

When all of the model parameters for all document-word combinations dᵢwⱼ have been updated, the model parameter updater 11 advises the controller 18 which causes the end point determiner 19, at S15 in FIG. 6, to calculate the log likelihood L in accordance with equation (12) using the updated model parameters and the word counts from the document word count matrix store 12.

The end point determiner 19 then checks at S16 whether or not the calculated log likelihood L meets a predefined condition and advises the controller 18 accordingly. The controller 18 causes the expected probability calculator 11a, model parameter updater 11b and end point determiner 19 to repeat S14 and S15 until the calculated log likelihood L meets the predefined condition. The predefined condition may, as set out in the above mentioned papers by Thomas Hofmann, be a preset maximum threshold or may be determined as a cut-off point at which the improvement in the log likelihood value L is less than a predetermined threshold or a preset maximum number of iterations.

Once the log likelihood L meets the predefined condition, then the controller 18 determines that the expectation-maximisation process has been completed and that the optimum model parameters or probabilities have been achieved. Typically 40-60 iterations by the expected probability calculator 11a and model parameter updater 11b will be required to reach this stage.

FIGS. 7 and 8 show in greater detail one way in which the expected factor probability calculator 11a and model parameter updater 11b may operate.

At S20 in FIG. 7, the expectation-maximisation module 11 initialises a temporary word-factor matrix and a temporary factor vector in an EM (expectation-maximisation) working memory store 11c of the memory 4. The temporary word-factor matrix and temporary factor vector have the same configurations as the word-factor matrix and factor vector stored in the word-factor matrix store 15 and factor vector store 13.

The expected probability calculator 11a then selects the next (the first in this case) document dᵢ to be processed at S21 and at S22 initialises a temporary document-factor vector in the working memory 11c store of the memory 4. The temporary document-factor vector has the configuration of a single row (representing a single document) of the document-factor matrix stored in the document-factor matrix store 14.

At S23 the expected probability calculator 11a selects the next (in this case the first) word wⱼ, at S24 selects the next factor zₖ (the first in this case) and at S25 calculates the numerator of equation (6) for the current document, word and factor by reading the model parameters from the appropriate elements of the factor vector store 13, document-factor matrix store 14 and word-factor matrix store 15 and the prior information from the appropriate elements of the prior information store 17a and stores the resulting value in the EM working memory 11c.

Then at S26, the expected probability calculator 11a checks to see whether there are any more factors to consider and, as the answer is at this stage yes, repeats S24 and S25 to calculate the numerator of equation (6) for the next factor but the same document and word combination.

When the numerator of equation (6) has been calculated for all factors for the current document and word combination, that is the answer at S26 is no, then at S27, the expected probability calculator 11a calculates the sum of all the numerators calculated at S25 and divides each numerator by that sum to obtain normalised values. These normalised values represent the expected probability values for each factor for the current document word combination.

The expected probability calculator 11a passes these values to the model parameter updater 11b which, at S28 in FIG. 8, for each factor, multiples the word count n(dᵢ,wⱼ) for the current document word combination by the expected probability value for that factor to obtain a model parameter numerator component and adds that model parameter numerator component to the cell or element corresponding to that factor in the temporary document-factor vector, the temporary word-factor matrix and the temporary factor-vector in the EM working memory 11c.

Then at S29, the expectation-maximisation module 11 checks whether all the words in the word count matrix 12 have been considered and repeats S23 to S29 until all of the words for the current document have been processed.

At this stage:

1) each cell in the temporary document-factor vector will contain the sum of the model parameter numerator components for all words for that factor and document, that is the numerator value for equation (9) for that document:

$${\sum }_{j = 1}^{M} n ( {d}_{i} , {w}_{j} ) P ( {z}_{k} \vert {d}_{i} , {w}_{j} ) \qquad ( 9 a )$$

2) each cell in the temporary word-factor matrix will contain a model parameter numerator component for that word and that factor constituting one component of the numerator value of equation (8), that is:

n(dᵢ,wⱼ)P(zₖ|dᵢ,wⱼ) (10a)

3) each cell in the temporary factor vector will, like the temporary document-factor vector, contain the sum of the model parameter numerator components for all words for that factor.

Thus, at this stage, all of the model parameter numerator values of equation (9) will have been calculated for one document and stored in the temporary document-factor vector. At S30 the model parameter updater 11b updates the cells (the row in this example) of the document factor matrix corresponding to that document by copying across the values from the temporary document-factor vector.

Then at S31, the expectation-maximisation module 11 checks whether there are any more documents to consider and repeats S21 to S31 until the answer at S31 is no. At this stage, because the model parameter updater 11b updates the cells (the row in this example) of the document factor matrix corresponding to the document being processed by copying across the values from the temporary document-factor vector each time S30 is repeated, each cell of the document factor-matrix will contain the responding model parameter numerator value. Also, at this stage each cell in the temporary word-factor matrix will contain the corresponding numerator value for equation (8) and each cell in the temporary factor vector will contain the corresponding numerator value for equation (10).

Then at S32, the model parameter updater 11b updates the factor vector by copying across the values from the corresponding cells of the temporary factor vector and at S33 updates the word-factor matrix by copying across the values from the corresponding cells of the temporary word-factor matrix.

Then at S34, the model parameter updater 11b:

1) normalises the word-factor matrix by, for each factor, summing the corresponding model parameter numerator values, dividing each model parameter numerator value by the sum and storing the resulting normalised model parameter values in the corresponding cells of the word-factor matrix;

2) normalises the document-factor matrix by, for each factor, summing the corresponding model parameter numerator values, dividing each model parameter numerator value by the sum and storing the resulting normalised model parameter values in the corresponding cells of the document-factor matrix; and

3) normalising the factor vector by summing all of the word counts to obtain R and then dividing each model parameter numerator value by R and storing the resulting normalised model parameter values in the corresponding cells of the factor vector.

The expectation-maximisation procedure is thus an interleaved process such that the expected probability calculator 11a calculates expected probability values for a document, passes these onto the model parameter updater 11b which, after conducting the necessary calculations on those expected probability values, advises the expected probability calculator 11a which then calculates expected probability values for the next document and so on until all of the documents in the training set have been considered. At this point, the controller 18 instructs the end point determiner 19 which then determines the log likelihood as described above in accordance with equation (12) using the updated model parameters or probabilities stored in the memory 4.

The controller 18 causes the processes described above with reference to FIGS. 6 to 8 to be repeated until the log likelihood L reaches a desired threshold value or, as described in the aforementioned paper by Thomas Hofmann, the improvement in the log likelihood has reached a limit or threshold, or a maximum number of iterations have been carried out.

The results of the document analysis may then be presented to the user as will be described in greater detail below and the user may then choose to refine the analysis by manually adjusting the topic clustering.

The information analysing apparatus shown in FIG. 1 implements a document by term model. FIG. 9 shows a functional block diagram of information analysing apparatus similar to that shown in FIG. 1 that implements a term by term (word by word) model rather than a document by term model which allows a more compact representation of the training data to be stored which is less dependent on the number of documents and allows many more documents to be processed.

As can be seen by comparing the information analysing apparatus 1 shown in FIG. 1 and the information analysing apparatus 1a shown in FIG. 9, the information analysing information 1a differs from that shown in FIG. 1 in that the document word count determiner 10 of the document processor is replaced by a word window word count determiner 10a that effectively defines a window of words wbⱼ (wb₁ . . . wb_{M}) around a word waᵢ in words extracted from documents by the word extractor and determines the number of occurrences of each word wbⱼ within that window and then moves the window so that it is centred on another word waᵢ(wa₁ . . . wa_{T}).

Thus, in this example, the word window word count determiner 10a is arranged to determine the number of occurrences of words wb₁ to wb_{M} in word windows centred on words wa₁ . . . wa_{T}, respectively. As shown in FIG. 9a, the document word count matrix 12 of FIG. 1 is replaced by a word window word count matrix 120 having elements 120a. Similarly, as shown in FIG. 9c, the document-factor matrix is replaced by a word window factor matrix 140 having elements 140a and, as shown in FIG. 9d, the word-factor matrix is replaced by a word-factor matrix 150 having elements 150a. Generally, the set of words wa₁ . . . wa_{T} will be identical to the set of words wb₁ . . . wb_{T}, and so the word window factor matrix 140 may be omitted. The factor vector is unchanged as can be seen by comparing FIGS. 3b and 9b and the prior information matrices in the prior information store 17a will have configuration similar to the matrices shown in FIGS. 9c and 9d.

In this case, the probability of a word in a word window based on another word is decomposed into the probability of that word given factor z and the probability of factor z given the other word. The expected probability calculator 11a is configured in this case to compute equation (13) below:

$$P ( {z}_{k} \vert {wa}_{i} , {wb}_{j} ) = \frac{\hat{P} ( {z}_{k} \vert {wa}_{i} ) \hat{P} ( {z}_{k} \vert {wb}_{j} ) {P ( {z}_{k} ) [ P ( {wa}_{i} \vert {z}_{k} ) P ( {wb}_{j} \vert {z}_{k} ) ]}^{β}}{{\sum }_{{k}^{′} = 1}^{K} \hat{P} ( {z}_{{k}^{′}} \vert {wa}_{i} ) \hat{P} ( {z}_{{k}^{′}} \vert {wb}_{j} ) {P ( {z}_{{k}^{′}} ) [ P ( {wa}_{i} \vert {z}_{{k}^{′}} ) P ( {wb}_{j} \vert {z}_{{k}^{′}} ) ]}^{β}} \qquad ( 13 )$$

where:

$$\hat{P} ( {z}_{k} \vert {wb}_{j} ) = \frac{{ⅇ}^{γ {u}_{jk}}}{\sum {ⅇ}^{γ {u}_{jk}}} \qquad ( 14 a )$$

represents prior information provided by the prior information determiner 17 for the probability of the factor zₖ given the word wbⱼ with γ being a value determined by the user of the overall importance of the prior information and uⱼₖ being a value determined by the user indicating the importance of the particular term or word, and

$$\hat{P} ( {z}_{k} \vert {wa}_{i} ) = \frac{λ {v}_{ik}}{\sum {ⅇ}^{λ {v}_{{ik}^{′}}}} \qquad ( 14 b )$$

represents prior information provided by the prior information determiner 17 for the probability of the factor zₖ given the word waᵢ with λ being a value determined by the user of the overall importance of the prior information and vᵢₖ being a value determined by the user indicating the importance of the particular word waᵢ. Where there is only one word set then equation (14b) will be omitted. As in the above example described with reference to FIG. 1, the user may be given the option only to input prior information for equation (14a) and a uniform probability distribution may be adopted for equation (14b).

In the case of the information analysis apparatus shown in FIG. 9, the model parameter updater 11b is configured to calculate the probability of wb given z, P(wbⱼ|zₖ), the probability of wa given z, P(waᵢ|zₖ), and the probability of z, P(zₖ) in accordance with equations (15), (16) and (17) below:

$$\begin{matrix}P ( {wb}_{j} \vert {z}_{k} ) = \frac{{\sum }_{i = 1}^{T} n ( {wa}_{i} , {wb}_{j} ) P ( {z}_{k} \vert {wa}_{i} , {wb}_{j} )}{{\sum }_{i = 1}^{T} {\sum }_{{j}^{′} = 1}^{M} n ( {wa}_{i} , {wb}_{{j}^{′}} ) P ( {z}_{k} \vert {wa}_{i} , {wb}_{{j}^{′}} )} & ( 15 ) \\ P ( {wa}_{i} \vert {z}_{k} ) = \frac{{\sum }_{j = 1}^{M} n ( {wa}_{i} , {wb}_{j} ) P ( {z}_{k} \vert {wa}_{i} , {wb}_{j} )}{{\sum }_{{i}^{′} = 1}^{T} {\sum }_{j = 1}^{M} n ( {wa}_{{i}^{′}} , {wb}_{j} ) P ( {z}_{k} \vert {wa}_{{i}^{′}} , {wb}_{j} )} & ( 16 ) \\ P ( {z}_{k} ) = \frac{1}{R} {\sum }_{i = 1}^{T} {\sum }_{j = 1}^{M} n ( {wa}_{i} , {wb}_{j} ) P ( {z}_{k} \vert {wa}_{i} , {wb}_{j} ) & ( 17 )\end{matrix}$$

where R is given by equation (18) below:

$$R ≡ {\sum }_{i = 1}^{T} {\sum }_{j = 1}^{M} n ( {wa}_{i} , {wb}_{j} ) \qquad ( 18 )$$

and n(waᵢ,wbⱼ) is the number of occurrences or count for a given word wbⱼ in a word window centred on waᵢ as determined from the word count matrix store 120.

In FIG. 9, the end point determiner 19 is arranged to calculate a log likelihood L in accordance with equation (19) below:

$$L = {\sum }_{i = 1}^{T} {\sum }_{j = 1}^{M} n ( {wa}_{i} , {wb}_{j} ) log P ( {wa}_{i} , {wb}_{j} ) \qquad ( 19 )$$

It will be seen from the above that equations (13) to (19) correspond to equations (6) to (12) above with dᵢ replaced by waᵢ, wⱼ replaced by waⱼ and the number of documents N replaced by the number of word windows T. Thus in the apparatus shown in FIG. 9, the expected probability calculator 11a, model parameter updater 11b and end point determiner 19 are configured to implement an expectation-maximisation (EM) algorithm to determine the model parameters P(wbⱼ|zₖ), P(waᵢ|zₖ) and P(zₖ) for which the log likelihood L is a maximum so that, at the end of the expectation-maximisation process, the terms or words in the set of word windows T will have been clustered in accordance with the factors and the prior information specified by the user.

FIG. 10 shows a flow chart illustrating the overall operation of the information analysing apparatus 1a shown in FIG. 9.

Thus, at S50 the word count matrix 12a is initialised, then at S51, the word count determiner 10a determines whether there are any more word windows to consider and if the answer is no proceeds to perform the expectation-maximisation at S54. If, however, there are more word windows to be considered, then, at S52, the word count determiner 10a moves the word window to the next word waᵢ to be processed, counts the occurrence of each of the words wbⱼ in that window and updates the word count matrix 120.

Where the word sets wbⱼ and waᵢ are different then the operations carried out by the expected probability calculator 11a, model parameter updater 11b and end point determiner 19 will be as described above with reference to FIGS. 6 to 8 with the documents dᵢ replaced by word windows based on words waᵢ, the document factor matrix replaced by the word window factor matrix and the temporary document vector replaced by the temporary word window vector.

Generally, however, the word sets wbⱼ and waᵢ will be identical so that T=M and there is a single word set wbⱼ. This means that equations (15) and (16) will be identical so that it is only necessary for the model parameter updater 11b to calculate equation (15) and the user need only specify prior information for the one word set wbⱼ, that is equation (14b) will be omitted.

Operation of the expectation maximisation processor 3 where there is there is a single word set wbⱼ will now be described with the help of FIGS. 11 to 13. The user interface for inputting prior information will be similar to that described above with reference to FIGS. 4a to 4c because the user is again inputting prior information regarding words.

FIG. 11 shows the expectation-maximisation operation of S54 of FIG. 10 in this case. At S60 in FIG. 11 the initial parameter determiner 16 initialises the word-factor matrix store 15 and factor vector store 13 by determining randomly generated normalised initial model parameters or probabilities and storing in the corresponding elements in the factor vector store 13 and the word-factor matrix store 15, that is initial values for the probabilities P(zₖ), and P(wⱼ|zₖ).

The prior information determiner 17 then, at S61 in FIG. 11, reads the prior information input via the user input 5 as described above with reference to FIG. 4c and at S62 calculates the prior information distribution in accordance with equation (14a) and stores it in the prior information store 17a.

The prior information determiner 17 then advises the controller 18 that the prior information is available in the prior information store 17a which then instructs the expectation-maximisation module 11 to commence the expectation-maximisation procedure and at S63 the expectation-maximisation module 11 determines the control parameter β as described above.

Then at S64 the expected probability calculator 11a calculates the expected probability values in accordance with equation (13) using the prior information stored in the prior information store 17a and the initial model parameters or probability factors stored in the factor vector store 13 and the word factor matrix store 15, and the model parameter updater 11b updates the model parameters in accordance with equations (15) and (17) and stores the updated model parameters in the appropriate store 13 or 15.

When all of the model parameters for all word window and word combinations waᵢwbⱼ have been updated, the model parameter updater 11 advises the controller 18 which causes the end point determiner 19, at S65 in FIG. 11, to calculate the log likelihood L in accordance with equation (19) using the updated model parameters and the word counts from the word count matrix store 120.

The end point determiner 19 then checks at S66 whether or not the calculated log likelihood L meets a predefined condition and advises the controller 18 accordingly. The controller 18 causes the expected probability calculator 11a, model parameter updater 11b and end point determiner 19 to repeat S64 and S65 until the calculated log likelihood L meets the predefined condition as described above.

FIGS. 12 and 13 show in greater detail one way in which the expected factor probability calculator 11a and model parameter updater 11b may operate in this case.

At S70 in FIG. 12, the expectation-maximisation module 11 initialises a temporary word-factor matrix and a temporary factor vector in the EM working memory 11c store of the memory 4. The temporary word-factor matrix and temporary factor vector again have the same configurations as the word-factor matrix and factor vector stored in the word-factor matrix store 15 and factor vector store 13.

The expected probability calculator 11a then selects the next (the first in this case) word window waᵢ to be processed at S71 and at S73 selects the next (in this case the first word) wbⱼ.

At S74, the expected probability calculator 11a selects the next factor zₖ (the first in this case) and at S75 calculates the numerator of equation (13) for the current word window, word and factor by reading the model parameters from the appropriate elements of the factor vector 13 and word-factor matrix 15 and the prior information from the appropriate elements of the prior information store 17a and stores the resulting value in the EM working memory 11c.

Then at S76, the expected probability calculator 11a checks to see whether there are any more factors to consider and, as the answer is at this stage yes, repeats S74 and S75 to calculate the numerator of equation (13) for the next factor but the same word window and word combination.

When the numerator of equation (13) has been calculated for all factors for the current word window word combination, that is the answer at S76 is yes, then at S77, the expected probability calculator 11a calculates the sum of all the numerators calculated at S75 and divides each numerator by that sum to obtain normalised values. These normalised values represent the expected probability value for each factor for the current word window word combination.

The expected probability calculator 11a passes these values to the model parameter updater 11b which at S78 in FIG. 13, for each factor, multiples the word count n(waᵢ,wbⱼ) for the current word window word combination by the expected probability value for that factor to obtain a model parameter numerator component and adds that model parameter numerator component to the cell or element corresponding to that factor in the temporary word-factor matrix and the temporary factor-vector in the EM working memory 11c.

Then at S79, the expectation-maximisation module 11 checks whether all the words in the word count matrix 12 have been considered and repeats the operations of S73 to S79 until all of the words for the current word window have been processed. At this stage:

1) each cell in the row of the temporary word-factor matrix for the word window waᵢ will contain the sum of the model parameter numerator components for all words for that factor, that is the numerator value for equation (15) for that word window;

$${\sum }_{j = 1}^{M} n ( {wa}_{i} , {wb}_{j} ) P ( {z}_{k} \vert {wa}_{i} , {wb}_{j} ) \qquad ( 15 a )$$

2) each cell in the temporary factor vector will, like the row of the temporary word-factor matrix, contain the sum of the model parameter numerator components for all words for that factor.

Thus at this stage the model parameter numerator values of equation (15) will have been calculated for one word window and stored in the corresponding row of the temporary word-factor matrix.

Then at S81, the expectation-maximisation module 11 checks whether there are any more word windows to consider and repeats S71 to S81 until the answer at S81 is no.

At this stage, each cell in the temporary word-factor matrix will contain the corresponding numerator value for equation (15) and each cell in the temporary factor vector will contain the corresponding numerator value for equation (17).

Then at S82, the model parameter updater 11b updates the factor vector by copying across the values from the corresponding cells of the temporary factor vector and at S83 updates the word-factor matrix by copying across the values from the corresponding cells of the temporary word-factor matrix.

Then at S84, the model parameter updater 11b:

1) normalises the word-factor matrix by, for each factor, summing the corresponding model parameter numerator values, dividing each model parameter numerator value by the sum and storing the resulting normalised model parameter values in the corresponding cells of the word-factor matrix; and

2) normalising the factor vector by summing all of the word counts to obtain R and then dividing each model parameter numerator value by R and storing the resulting normalised model parameter values in the corresponding cells of the factor vector.

Thus, in this case, each word window is an array of words wbⱼ associated with the word waᵢ, the frequencies of co-occurrence n(waᵢ,wbⱼ), that is the word-word frequencies, are stored in the word count matrix and an iteration process is carried out with each word waᵢ and its associated word window being selected in turn and, for each word window, each word wbⱼ being selected in turn.

The expectation-maximisation procedure is thus an interleaved process such that the expected probability calculator 11a calculates expected probability values for a word window, passes these onto the model parameter updater 11b which, after conducting the necessary calculations on those expected probability values, advises the expected probability calculator 11a which then calculates expected probability values for the next word window and so on until all of the word windows in the training set have been considered. At this point, the controller 18 instructs the end point determiner 19 which then determines the log likelihood as described above in accordance with equation (12) using the updated model parameters or probabilities stored in the memory 4.

The controller 18 causes the processes described above with reference to FIGS. 11 to 13 to be repeated until the log likelihood L reaches a desired threshold value or, as described in the aforementioned paper by Thomas Hofmann, the improvement in the log likelihood has reached a limit or threshold, or a maximum number of iterations have been carried out.

The results of the analysis may then be presented to the user as will be described in greater detail below and the user may then choose to refine the analysis by manually adjusting the topic clustering.

As can be seen by comparison of FIGS. 6 and 11 operations S60 to S66 of FIG. 11 correspond to operations S10 to S16 of FIG. 6 with the only difference being that at S60 it is the word factor matrix rather than the document factor and word factor matrices that is initialised. In other respects, the general operation is similar although the details of calculation of the expectation values and updating of the model parameters are somewhat different

In either the examples described above, when the end point determiner 19 determines that the end point of the expectation-maximisation process has been reached, then the result of the clustering or analysis procedure is output to the user by the output controller 6a and the output 6, in this case by display to the user on the display 31 shown in FIG. 2 for example the display screen 80a shown in FIG. 14.

In this example, the output controller 6a is configured to cause the output 6 to provide the user with a tabular display that identifies any topic label preassigned by the user as described above with reference to FIG. 4c and also identifies the terms or words preassigned to each topic by the user as described above and the terms or words allocated to a topic as a result of the clustering performed by the information analysing apparatus 1 or 1a. Thus, the output controller 6a reads data in the memory 4 associated with the factor vector 13 and defining the topic number and any topic label preassigned by the user and retrieves from the word factor matrix store 15 in FIG. 1 (or the word a factor matrix 15 in FIG. 9) the words associated with each factor and allocates them to the corresponding topic number differentiating terms preassigned by the user from terms allocated during the clustering process carried out by the information analysing apparatus and then supplies this data as output data to the output 6.

In the example illustrated by FIG. 14, this information is represented by the output controller 6a and output 6a as a table similar to the table shown in FIG. 4c having a first row 81 labelled topic number, a second row 82 labelled topic label, a set of rows 83 labelled preassigned terms and a set of rows 84 labelled allocated terms and columns 1 to 3, 4 and so on representing the different topics or factors. Scroll bars 85 and 86 are again associated with the table to enable a user to scroll up and down the rows and to the left and right through the column so as to enable the user to view the clustering of terms to each topic.

The display screen 80a shown in FIG. 14 has a number of drop down menus only one of which, drop down menu 90, is shown labelled in FIG. 14. When this drop down menu labelled “options” is selected, the user is provided with a list of options which include, as shown in FIG. 14a (which is a view of part of FIG. 14) options 91 to 95 to add documents, edit terms, edit relevance, re-run the clustering or analysing process and to accept the current word-topic allocation determined as a result of the last clustering process, respectively.

If the user selects the “edit relevance” option 93 using the pointing device after having highlighted or selected a term, whether a preassigned term or an allocated term, then a pop up menu similar to that shown in FIG. 4c will appear enabling the user to edit the general relevance of the preassigned term and also the relevance of any of the terms. Similarly, if the user selects the “edit terms” options 92 using the pointing device, then the user will be free to delete a term from a topic and to move a term between topics using conventional windows type delete, cut and paste and drag and drop facilities. If the user selects the option “add document” 91 then, as shown very diagrammatically in FIG. 15, a window 910 may be displayed including a drop down menu 911 enabling a user to select from a number of different directories in which a document may be stored and a document list window 912 configured to list documents available in the selected directory. A user may select documents to be added by highlighting them using the pointing device in conventional manner and then selecting an “OK” button 913.

Operation of the information analysing apparatus 1 or 1a when a user elects to add a document or a passage of text to the document database will now be described with reference to FIG. 16.

A folding-in process is used to enable a new document or passage of text to be added to the database. Thus, at S100 in FIG. 16, the document receiver 7 receives the new document or passage of text “a” from the document database 300 and at S101 the word extractor 8 extracts words from the document in the manner as described above. Then at S102, the word count determiner 10 or 10a determines the number of times n(a,wⱼ) the terms wⱼ occur in the new text or document, and updates the word count matrix 12 or 12a accordingly.

Then at S103 the expectation-maximisation processor 3 performs an expectation-maximisation process.

FIG. 17 shows the operation of S103 in greater detail. Thus, at S104, the initial parameter determiner 16 initialises P(zₖ|a) to random, normalised, near uniform, values, and at S105 the expected probability calculator 11a then calculates expected probability values P(zₖ|a,wⱼ) in accordance with equation (20) below:

$$P ( {z}_{k} \vert a , {w}_{i} ) = \frac{{P ( {z}_{k} \vert a ) [ P ( {w}_{i} \vert {z}_{k} ) ]}^{β}}{{\sum }_{{k}^{′} = 1}^{K} {P ( {z}_{{k}^{′}} \vert a ) [ ( {w}_{i} \vert {z}_{{k}^{′}} ) ]}^{β}} \qquad ( 20 )$$

which corresponds to equation (5) substituting a for d and replacing P(a|zₖ) with P(zₖ|a) using Bayes theorem. The fitting parameter β is set to more than zero but less than or equal to one, with the actual value of β controlling how specific or general the representation or probabilities of the factors z given a, P(zₖ|a), is.

At S106, the model parameter updater 11b then calculates updated model parameters P(zₖ|a) in accordance with equation (21) below:

$$P ( {z}_{k} \vert a ) = \frac{{\sum }_{j = 1}^{M} n ( a , {w}_{j} ) P ( {z}_{k} \vert a , {w}_{j} )}{{\sum }_{{k}^{′} = 1}^{K} {\sum }_{j = 1}^{M} n ( a , {w}_{j} ) P ( {z}_{k} \vert a , {w}_{j} )} \qquad ( 21 )$$

In this case, at S107, the controller 18 causes the expected probability calculator 11a and model parameter updater 11b to repeat these steps until the end point determiner 19 advises the controller 18 that a predetermined number of iterations has been completed or P(zₖ|a) does not change beyond a threshold.

Two or more documents or passages of text can be folded-in in this manner.

In use of the apparatus described above with reference to FIG. 9, it may be desirable to generate a representation P(zₖ|w′) for a term w′ that was not in the training set, for example because the term occurred too frequently or too infrequently and so was not included by the word count determiner 10a, or was not present in the training set. In this case, the word count determiner 10a first determines the co-occurrence frequencies or word counts n(w′,wⱼ) for the new term w′ and the terms wⱼ used in the training process from new passages of text (new word windows) received from the document pre-processor and stores these in the word count matrix 12a. The expectation-maximisation processor 3 can then fold-in the new terms in accordance with equations (20) and (21) above with “a” replaced by “w′”. The resulting representations P(zₖ|w′) for the new or unseen terms can then be stored in the database in a manner analogous to the representations P(zₖ|wⱼ) for the terms analysed in the training set.

When a long passage of text or document is folded in then there should be sufficient terms in new text that are already present in the word count matrix to enable generation of a reliable representation by the folding-in process. However, if the passage is short or contains a large proportion of terms that were not in the training data, then the folding-in process needs to be modified as set out below.

In this case the word counts for the new terms are determined by the word count determiner 10a as described above with reference to FIG. 9, the representations or factor-word probabilities P(zₖ|w′) are initialised to random normalised, near uniform values by the initial parameter determiner 16 and then the expected probability calculator 11a calculates expected probability values P(zₖ|a,wⱼ) in accordance with equation (20) above for the terms that were already present in the database and, using Bayes theorem, in accordance with equation (22) below for the new terms:

$$P ( {z}_{k} \vert a , {w}_{{j}^{′}}^{′} ) = \frac{{P ( {z}_{k} \vert a ) [ P ( {z}_{k} \vert {w}_{j}^{′} ) / P ( {z}_{k} ) ]}^{β}}{{\sum }_{{k}^{′} = 1}^{K} {P ( {z}_{{k}^{′}} \vert a ) [ P ( {z}_{{k}^{′}} \vert {w}_{j}^{′} ) / P ( {z}_{{k}^{′}} ) ]}^{β}} \qquad ( 22 )$$

The fitting parameter β is set to more than zero but less than or equal to one, with the actual value of β controlling how specific or general the representation or probabilities of the factors z given w′, P(zₖ|a), is.

The model parameter updater 11b then calculates updated model parameters P(zₖ|a) in accordance with equation (23) below:

$$P ( {z}_{k} \vert a ) = \frac{{\sum }_{j = 1}^{M} n ( a , {w}_{j} ) P ( {z}_{k} \vert a , {w}_{j} ) + {\sum }_{j = 1}^{B} n ( a , {w}_{j}^{′} ) P ( {z}_{k} \vert a , {w}_{j}^{′} )}{{\sum }_{k = 1}^{K} ( {\sum }_{j = 1}^{M} n ( a , {w}_{j} ) P ( {z}_{k} \vert a , {w}_{j} ) + {\sum }_{j = 1}^{B} n ( a , {w}_{j}^{′} ) P ( {z}_{k} \vert a , {w}_{j}^{′} ) )} \qquad ( 23 )$$

where n(a, wⱼ) is the count or frequency for the existing term wⱼ in the passage “a” and n(a, w′ⱼ) is the count or frequency for the new term w′ⱼ in the text passage “a” and there are M existing terms and B new terms.

The controller 18 in this case causes the expected probability calculator 11a and model parameter updater 11b to repeat these steps until the end point determiner 19 determines that a predetermined number of iterations has been completed or P(zₖ|a) does not change beyond a threshold.

The user can then edit the topics and rerun the analysis or add further new documents and rerun the analysis or accept the analysis, as described above.

Once a user has finished their editing of the relevance or allocation of terms and addition of any documents, then the user can instruct the information analysing apparatus to rerun the clustering process by selecting the “re-run” option 94 in FIG. 14a.

The clustering process may be run one more or many more times, and the user may edit the results as described above with reference to FIGS. 14 and 14a at each iteration until the user is satisfied with the clustering and has defined a final topic label for each topic. The user can then input final topic labels using the keyboard 28 and select the “accept” option 95, causing the output 6 of the information analysis apparatus 1 or 1a to output to the document database 300 information data associating each document (or word window) with the topic labels having the highest probabilities for that document (or word window) enabling documents subsequently to be retrieved from the database on the basis of the associated topic labels. At this stage the data stored in the memory 4 is no longer required, although the factor-word (or factor word b) matrix may be retained for reference.

The information analysing apparatus shown in FIG. 1 and described above was used to analyse 20000 documents stored in the database 300 and including a collection of articles taken from the Associated Press Newswire, the Wall Street Journal newspaper, and Ziff-Davis computer magazines. These were taken from the Tipster disc 2, used in the TREC information retrieval conferences.

These documents were processed by the document preprocessor 9 and the word extractor 8 found a total of 53409 unique words or terms appearing three or more times in the document set. The word extractor 8 was provided with a stop list of 400 common words and no word stemming was performed.

In this example, words or terms were pre-allocated to 4 factors, factor 1, 2, 3 and 4 of 50 available factors as shown in the following Table 1:

TABLE 1
Prior Information specified before training

| | |
|---|---|
| Factor 1 | computer, software, hardware |
| Factor 2 | environment, forest, species, animals |
| Factor 3 | war, conflict, invasion military |
| Factor 4 | stock, NYSE, shares, bonds |

The following Table 2 shows the results of the analysis carried out by the information processing apparatus 1 giving the 20 most probable words for each of these 4 factors:

TABLE 2
Top 20 most probable terms after training
using prior information

| | |
|---|---|
| Factor 1 | hardware, dos, os, windows, interface, |
| | server, files, memory, database, booth, |
| | Ian, mac, fax, package, features, unix, |
| | language, running, pcs, functions |
| Factor 2 | forest, species, animals, fish, wildlife, |
| | birds, endangered, environmentalists, |
| | florida, salmon, monkeys, balloon, circus, |
| | park, acres, scientists, zoo, cook, animal, |
| | owl |
| Factor 3 | opec, kuwait, military, iraq, war, barrels, |
| | aircraft, navy, conflict, force, defence, |
| | pentagon, ministers, barrel, saudi arabia, |
| | boeing, ceiling, airbus, mcdonnell, iraqi |
| Factor 4 | NYSE, amex, fd, na, tr, convertible, inco, |
| | 7.50, equity, europe, global, inv, |
| | fidelity, cap, trust, 4.0, 7.75, secs |

A comparison of Tables 1 and 2 shows that the prior information input by the user and shown in Table 1 has facilitated direction of the four factors to topics indicated generally by the pre-allocated words or terms. In this example, the relevant factor discussed above with reference to FIG. 4 was set at “ONLY” indicating that the pre-allocated term was to appear, as far as the 4 factors for which prior information was being input were concerned, only to appear in that particular factor.

For comparison purposes, the same data set was analysed using the existing PLSA algorithm described in the aforementioned papers by Thomas Hofmann with all of the same conditions and parameters except that no prior information was specified. At the end of this analysis, out of the 50 specified factors or topics three were found to show unnatural groupings of words or terms. Table 3 shows the results obtained for factors 1, 5, 10 and 25 with factors 5 and 10 being examples of good factors, that is where the existing PLSA algorithm has provided a correct grouping or clustering of words, and factors 1 and 25 being examples of bad or inconsistent factors wherein there is no discernible overall relationship or meaning shared by the clustered words or terms.

TABLE 3
Example of good factors (Factors 5 and 10) and
inconsistent factors (Factors 1 and 25)

| Factor 5 | Factor 10 | Factor 1 | Factor 25 |
|---|---|---|---|
| computer | company | pages | memory |
| systems | president | rights | board |
| ibm | executive | government | mhz |
| company | inc | data | south |
| inc | co | jan | northern |
| market | chief | technical | fair |
| corp | vice | contractor | ram |
| topic | corp | oct | mb |
| software | chairman | computer | rain |
| technology | companies | software | southern |

At the end of the information analysis or clustering process carried out by the information analysing apparatus 1 shown in FIG. 1 or the information analysing apparatus shown in FIG. 9, each document or word window is associated with a number of topics defined as the factors z for which the probability are being associated with that document or word window is highest. Data is stored in the database associating each document in the database with the factors or topics for which the probability is highest. This enables easy retrieval of documents having a high probability of being associated with a particular topic. Once this data has been stored in association with the document database, then the data can be used for efficient and intelligent retrieval of documents from the database on the basis of the defined topics, so enabling a user to retrieve easily from the database documents related to a particular topic (even though the word representing the topic (the topic label) may not be present in the actual document) and also to be kept informed or alerted of documents related to a particular topic.

Simple searching and retrieval of documents from the database can be conducted on the basis of the stored data associating each individual document with one or more topics. This enables a searcher to conduct searches on the basis of the topic labels in addition to terms actually present in the document. As a further refinement of this searching technique, the search engine may have access to the topic structures (that is the data associates each topic label with the terms or words allocated to that topic) so that the searcher need not necessarily search just on the topic labels but can also search on terms occurring in the topics.

Other more sophisticated searching techniques may be used based on those described in the aforementioned papers by Thomas Hofmann.

An example of a searching technique where an information database produced using the apparatus described above may be searched by folding-in a search query in the form of a short passage of text will now be described with the aid of FIGS. 18 and 19 in which FIG. 18 shows a display screen 80b that may be displayed to a user to input a search query when the user selects the option “search” in FIG. 4a. Again, this display screen 80b uses as an example a windows type interface. The display screen has a window 100 including a data entry box 101 for enabling a user to input a search query consisting of one or more terms and words, a help button 102 for enabling a user to access a help file to assist him in defining the search query and a search button 103 for instructing initiation of the search.

FIG. 19 shows a flow chart illustrating steps carried out by the information analysing apparatus when a user instructs a search by selecting the button 103 in FIG. 18.

Thus, at S110, the initial parameter determiner 16 initialises P(zₖ|q) for the search query input by the user.

Then at S111, the expectation maximisation processor calculates the expected probability P(zₖ|q,wⱼ), effectively treating the query as a new document or word window q, as the case may be, but without modifying the word counts in the word count matrix store in accordance with the words used in the query.

Then at S112 the output controller 6a of the information analysis apparatus compares the final probability distribution P(q|z) with the probability distribution P(d|z) for all documents in the database and at S114 returns to the user details of all documents meeting a similarity criterion, that is the documents for which the probability distribution most closely matches the probability distribution P(q|z).

In one example, the output controller 6a is arranged to compare two representations in accordance with equation (24) below:

$$\begin{matrix}D ( a ‖ q ) = {\sum }_{k = 1}^{K} P ( {z}_{k} \vert a ) log \frac{P ( {z}_{k} \vert a )}{P ( {z}_{k} \vert aorq )} + {\sum }_{k = 1}^{K} P ( {z}_{k} \vert q ) log \frac{P ( {z}_{k} \vert q )}{P ( {z}_{k} \vert aorq )} & ( 24 ) \\ where \\ P ( {z}_{k} \vert aorq ) = \frac{P ( {z}_{k} \vert a ) + P ( {z}_{k} \vert q )}{2} & ( 25 )\end{matrix}$$

As another possibility, the output controller 6a may use a cosine similarity matching technique as described in the aforementioned papers by Hofmann.

This searching technique thus enables documents to be retrieved which have a probability distribution most closely matching the determined probability distribution of the query.

In the above described embodiments, prior information is included by a user specifying probabilities for specific terms listed by the user for one or more of the factors. As another possibility, prior information may be incorporated by simulating the occurrence of “pivot words” added to the document data set. FIG. 20 shows a functional block diagram, similar to FIG. 1, of information analysing apparatus 1b arranged to incorporate prior information in this manner.

As can be seen by comparing FIGS. 1 and 20, the information analysing apparatus 1b differs from the information analysing apparatus 1 shown in FIG. 1 in that the prior information store is omitted and the prior information determiner 170 is instead coupled to the document word count matrix 1200. In addition, the configuration of the document word count matrix store 1200 and word factor matrix store 150 are modified so as to provide for the inclusion of the simulated pivot words, or tokens. FIGS. 21a and 21b are diagrams similar to FIGS. 3a and 3d, respectively, showing the configuration of the document word count matrix 1200 and the word factor matrix 150 in this example. As can be seen from FIGS. 21a and 21b the document word count matrix 1200 has a number of further columns labelled W_{M+1} . . . w_{M+Y} (where Y is the number of tokens or pivot words) and the word factor matrix 150 has a number of further rows labelled w_{M+1} . . . w_{M+Y} to provide further elements for containing count or frequency data and probability values, respectively, for the tokens w_{M+1} . . . w_{M+Y}.

In this example, when the user wishes to input prior information, the user is presented with a display screen similar to that shown in FIG. 4c except that the general weighting drop down menu 85 and the relevance drop down menu 90 are not required and may be omitted. In this case, the user inputs topic labels or names for each of the topics for which prior information is to be specified and, in addition, inputs the terms of prior information that the user wishes to be included within those topics into the cells of those columns.

The overall operation of the information analysing apparatus 1b is as shown in flow chart 5 and described above. However, the detail of the expectation-maximisation procedure carried out at S6 in FIG. 5 differs in the manner in which the prior information is incorporated and in the actual calculations carried out by the expected probability calculator. Thus, in this example, the prior information determiner 170 determines count values for the tokens w_{M+1} . . . w_{M+Y}, that is the topic labels, and adds these to the corresponding cells of the word count matrix 1200 so that the word count frequency values n(d,w) read from the word count matrix by the model parameter updater 11b and the end point determiner 19 include these values. In addition, in this example, the expected probability calculator 11a is configured to calculate probabilities in accordance with equation (5) not equation (6).

FIG. 22 shows a flow chart similar to FIG. 6 for illustrating the overall operation of the prior information determiner 170 and the expectation maximisation processor 3 shown in FIG. 20.

Processes S10 and S11 correspond to processes S10 and S11 in FIG. 6 except that, in this case, at S11, the prior information read from the user input consists of the topic labels or names input by the user and also the topic terms or words allocated to each of those topics by the user.

Once this information has been received, the prior information determiner 170 updates the word count matrix at S12a to add a count value or frequency for each token w_{M+1} . . . w_{M+Y} for each of the documents d₁ to d_{N}.

When the prior information determiner 170 has completed this task it advises the expected probability calculator 11a which then proceeds to calculate expected values of the current factors in accordance with equation (5) above and as described above with reference to FIGS. 6 to 8 except that, in this example, the expected probability calculator 11a calculates equation (5) rather than equation (6), and the summations of equations (8) to (10) by the model parameter updater 11b are, of course, effected for all counts in the count matrix that is w₁ . . . w_{M+Y}.

Then, at S15, the end point determiner 19 calculates the log likelihood in accordance with equation (12) but again effecting the summation from j=1 to M+Y.

The controller 18 end point determiner 19 then checks at S16 whether the log likelihood determined by the end point determiner 19 meets predefined conditions as described above and, if not, causes S13 to S16 to be repeated until the answer at S16 is yes, again as described above.

The manner in which the prior information determiner 170 updates the document word count matrix 1200 will now be described with the assistance of the flow chart shown in FIG. 23.

Thus at S120 the prior information determiner 170 reads the topic label token w_{M+Y} from the prior information input by the user and at S121 reads the user-defined terms associated with that token w_{M+Y} from the prior information. Then, at S122, the prior information determiner 170 determines from the word count matrix 1200 the word counts for document dᵢ for each of the user defined terms for that token w_{y}, sums these counts or frequencies and stores the resultant value in cell dᵢ, w_{M+y} of the word count matrix as the count or frequency for that token.

Then at S123, the prior information determiner increments dᵢ by 1 and, if at S124 dᵢ is not equal to d_{N+1}, repeats S122 and S123.

When the answer at S124 is yes, then a frequency or count for each of the documents d₁ to d_{N} will have been stored in the word count matrix for the topic label or token w_{M+y}

Then, at S125, the prior information determiner increments w_{M+y} by 1 and if w_{M+y} is not equal to w_{M+Y+1}, repeats steps S120 to S125 for that new value of w_{m+y}. When the answer at S126 is yes, then the word count matrix will store a count or frequency value for each document dᵢ and each topic label w_{M+Y}.

Thus, in this example, the word count matrix has been modified or biassed by the presence of the tokens or topic labels. This should bias the clustering process conducted by the expectation maximisation processor 3 to draw the prior terms specified by the user together into clusters.

After completion of the expectation maximisation process, the output controller 6a may check for correspondence between these clusters of words and the tokens to determine which cluster best corresponds to each set of prior terms and then allocate the clusters to the topic label so that each cluster of words is allocated to the topic label associated with the token that most closely corresponds to that cluster so that the cluster containing the prior terms associated with a particular token by the user is allocated to the topic label representing that token. This information may then be displayed to the user in a manner similar to that shown in FIG. 14 and the user may be provided with a drop down options menu similar to menu 90 shown in FIG. 14a, but without the facility to edit relevance, although it may be possible to modify the tokens.

As described above, the clustering procedure can be repeated after any such editing or additions by the user until the user is satisfied with the end result.

The results of the clustering procedure can be used as described above to facilitate searching and document retrieval.

It will, of course, be appreciated that the modifications described above with reference to FIGS. 20 to 23 may also be applied to the information analysing apparatus described above with reference to FIGS. 9 to 13 with S62 in FIG. 11 being modified as set out for S12a in FIG. 22, equation (13) being modified to omit the probability distributions given by equations (14a) and (14b) and equations (15) to (19) being modified to sum over j=1 to M+Y for the reasons described above.

In the above described examples operation of the expected probability calculator and model parameter updater 11b is interleaved and the EM working memory 11c is used to store a temporary document-factor vector, a temporary word-factor matrix and a temporary factor vector or a temporary word-factor matrix and a temporary factor vector. The EM working memory 11c may, as another possibility, provide an expected probability matrix for storing expectation values calculated by the expected probability calculator 11a and the expected probability calculator 11a may be arranged to calculate all expected probability values and then store these in the expected probability matrix for later use by the model parameter updater 11b so that, in one iteration, the expected probability calculator 11a completes its operations before the model parameter updater 11b starts its operations, although this would require significantly greater memory capacity than the procedures described above with reference to FIGS. 6 to 8 or FIGS. 11 to 13.

Where the expected probability values are all calculated first, then, because the denominator of equation (6) or (13) is a normalising factor consisting of a sum of the numerators, the expected factor probability calculator 11a may calculate the numerator, then store the resultant numerator value and also accumulate it to a running total value for determining the denominator and then, when the accumulated total represents the final denominator, divide each stored numerator value by the accumulated total to determine the values P(zₖ|dᵢ,wⱼ). The calculation of the actual numerator values may be effected by a series of iterations around a series of nested loops for i, j and k, incrementing i, j or k as the case may be each time the corresponding loop is completed. As another possibility, the dominator of equation (6) or (13) may be recalculated with each iteration, increasing the number of computations but reducing the memory capacity required. Where all of the expected probability values are calculated for one iteration before the model parameter updater 11b starts operation, then the model parameter updater 11b may calculate the updated model parameters P(dᵢ|zₖ) by: reading a first set of i and k values (that is a first combination of factor z and document d); calculating using equation (9) the model parameter P(dᵢ|zₖ) for those values using the word counts n(dᵢ,wⱼ) stored in the word count store 12; storing that model parameter in the corresponding document-factor matrix element in the store 14; then checking whether there is another set of i and k values to be considered and, if so, selecting the next set and repeating the above operations for that set until equation (9) has been calculated to obtain and store all of the model parameters P(dᵢ|zₖ). The model parameter updater 11b may then calculate the model parameters P(wⱼ|zₖ) by: selecting a first set of j and k values (that is a first combination of factor z and word w); calculating the model parameter P(wⱼ|zₖ) for those values using equation (8) and the word counts n(dᵢ,wⱼ) stored in the word count store 12 and storing that model parameter in the corresponding word-factor matrix element in the store 15; and repeating these procedures for each set of j and k values. When all the model parameters P(wⱼ|zₖ) have been calculated and stored, then the model parameter updater 11b may calculate the model parameter P(zₖ) by: selecting a first k value (that is a first factor z); calculating the model parameter P(zₖ) for that value using the word counts n(dᵢ,wⱼ) stored in the word count store 12 and equation (10) and storing that model parameter in the corresponding factor vector element in the store 13 and then repeating these procedures for each other k value. Because the denominators of equations (8), (9) and (10) are normalising factors comprising sums of the numerators, the model parameter updater 19 may, like the expected factor probability calculator 11, calculate the numerators, store the resultant numerator values, accumulate them to a running total and then, when the accumulated total represents the final denominator, divide each stored numerator value by the accumulated total to determine the model parameters. The calculation of the actual numerator values may be effected by a series of iterations around a series of nested loops, incrementing i, j or k as the case may be each time the corresponding loop is completed. As another possibility, the dominator of equations (8), (9) and (10) may be recalculated with each iteration, increasing the number of computations but reducing the memory capacity required.

A similar procedure may be used for the apparatus shown in FIG. 9 or 20 with in the case of FIG. 9 only the model parameters P(wⱼ|zₖ) and P(zₖ) being calculated by the model parameter updater where there is a single word set.

It may be possible to configure information analysing apparatus so that prior information is determined both as described above with reference to FIGS. 1 to 8 or FIGS. 9 to 13 and as described above with reference to FIGS. 22 and 23.

In the embodiments described above with reference to FIGS. 1 to 8 and 9 to 13, equations (7a) and (7b) and (14a) and (14b) are used to calculate the probability distributions for the prior information. Other methods of determining the prior information values may be used. For example, a simple procedure may be adopted whereby specific normalised values are allocated to the terms selected by the user in accordance with the relevance selected by the user on the basis of, for example, a lookup table of predefined probability values. As another possibility the user may be allowed to specify actual probability values.

As described above, the probability distributions of equations (7b) and (14b), if present, are uniform. In other examples, a user may be provided with the facility to input prior information regarding the relationship of documents to topics where, for example, the user knows that a particular document is concerned primarily with a particular topic.

In the above-described embodiments, the document processor, expectation maximisation processor, prior information determiner, user input, memory, output and database all form part of a single apparatus. It will, however, be appreciated that the document processor and expectation maximisation processor, for example, may be implemented by programming separate computer apparatus which may communicate directly or via a network such as a local area network, wide area network, an Internet or an Intranet. Similarly, the user input 5 and output 6 may be remotely located from the rest of the apparatus on a computing apparatus configured as, for example, a browser to enable the user to access the remainder of the apparatus via such a network. Similarly, the database 300 may be remotely located from the other components of the apparatus. In addition, the prior information determiner 17 may be provided by programming a separate computing apparatus. In addition, the memory 4 may comprise more than one storage device with different stores being located on different or the same stores, dependent upon capacity. In addition, the database 300 may be located on a separate storage device from the memory 4 or on the same storage device.

Information analysing apparatus as described above enables a user to decide which topics or factors are important but does not require all factors or topics to be given prior information, so leaving a strong element of data exploration. In addition, the factors or topics can be pre-labelled by the user and this labelling then verified after training. Furthermore, the information analysis and subsequent validation by the user can be repeated in a cyclical manner so that the user can check and improve the results until they meet his or her satisfaction. In addition, the information analysing apparatus can be retained on new data without affecting the labelling of the factors or terms.

AS described above, the word count is carried out at the time of analysis. It may however be accrues out at an earlier time or by a separate apparatus. Also, different user interfaces than those described above may be used, for example at least part of the user interface may be verbal rather than visual. Also, the data used and/or produced by the expectation-maximisation processor may be stored as other than a matrix or vector structure.

In the above-described examples, the items of information are documents or sets of words (within word windows). The present invention may also be applied to other forms of dyadic data, for example it may be possible to cluster items of images containing particular textures or patterns, for example.

Information analysing apparatus is described for clustering information elements in items of information into groups of related information elements. The apparatus has an expected probability calculator (11a), a model parameter updater (11b) and an end point determiner (19) for iteratively calculating expected probabilities using first, second and third model parameters representing probability distributions for the groups, for the elements and for the items, updating the model parameters in accordance with the calculated expected probabilities and count data representing the number of occurrences of elements in each item of information until a likelihood calculated by the end point determiner meets a given criterion.

The apparatus includes a user input 5 that enables a user to input prior information relating to the relationship between at least some of the groups and at least some of the elements. At least one of the expected probability calculator 11a, the model parameter updater 11b and the likelihood calculator is arranged to use prior data derived from the user input prior information in its calculation. In one example, the expected probability calculator uses the prior data in the calculation of the expected probabilities and in another example, the count data used by the model parameter updater and the likelihood calculator is modified in accordance with the prior data.

1. Information analysing apparatus for clustering information elements in items of information into groups of related information elements, the apparatus comprising:
a count data provider for providing count data representing the number of occurrences of elements in each item of information;
an initial model parameter determiner for determining first model parameters representing a probability distribution for the groups, second model parameters representing for each element the probability for each group of that element being associated with that group, and third model parameters representing for each item the probability for each group of that item being associated with that group;
a user input receiver for enabling a user to input prior information relating to the relationship between at least some of the groups and at least some of the elements;
a prior data determiner for determining from prior information input by a user using the user input receiver prior probability data for at least some of the second model parameters;
an expected probability calculator for receiving the first, second and third model parameters and the prior probability data and for calculating, for each item of information and for each information element of that item, the expected probability of that item and that element being associated with each group using the first, second and third model parameters and the prior probability data determined by the prior data determiner;
a model parameter updater for updating the first, second and third model parameters in accordance with the expected probabilities calculated by the expected probability calculator and the count data stored by the count data provider;
a likelihood calculator for calculating a likelihood on the basis of the expected probabilities and the count data stored by the count data provider; and
a controller for causing for causing the expected probability calculator, the model parameter updater and the likelihood calculator to recalculate the expected probabilities using the prior probability data and updated model parameters, to update the model parameters and to recalculate the likelihood, respectively, until the likelihood meets a given criterion.

2. Apparatus according to claim 1, wherein the user input receiver is arranged to enable a user to input prior information by specifying the allocation of information elements to groups.

3. Apparatus according to claim 2, wherein the user input receiver comprises a user interface configured to display a table having cells arranged in rows and columns with one of the columns and rows representing groups and the other representing information elements and the user input receiver is arranged to associate an information element with a group when that information element is placed by the user in a cell in the row or column representing that group.

4. Apparatus according to claim 2, wherein the user input receiver is arranged to enable a user to specify a relevance of an allocated information element to a group.

5. Apparatus according to claim 1, wherein the user input receiver is arranged to enable a user to input data indicating the overall relevance of prior information input by the user.

6. Apparatus according to claim 1, wherein the expected probability calculator is arranged to calculate the expected probabilities of a given item and element being associated with each of the groups by, for each group, obtaining a numerator value group by multiplying the first model parameter, the second model parameter, the third model parameter and the prior probability data for that group, item and element, and then normalising by dividing by the sum of the numerators for each group.

7. Information analysing apparatus for clustering information elements in items of information into groups of related information elements, the apparatus comprising:
a count data provider for providing count data representing the number of occurrences of elements in each item of information;
an initial model parameter determiner for determining first model parameters representing a probability distribution for the groups, second model parameters representing for each element the probability for each group of that element being associated with that group, and third model parameters representing for each item the probability for each group of that item being associated with that group;
a user input receiver for enabling a user to input prior information for modifying the count data;
a prior data determiner for determining from prior information input by a user using the user input receiver prior data and for modifying the count data provided by the count data provider in accordance with the prior data to provide modified count data;
an expected probability calculator for receiving the first, second and third model parameters and for calculating, for each item of information and for each information element of that item, the expected probability of that item and that element being associated with each group using the first, second and third model parameters;
a model parameter updater for updating the first, second and third model parameters in accordance with the expected probabilities calculated by the expected probability calculator and the modified count data;
a likelihood calculator for calculating a likelihood on the basis of the expected probabilities and the modified count data; and
a controller for causing for causing the expected probability calculator, the model parameter updater and the likelihood calculator to recalculate the expected probabilities using updated model parameters, to update the model parameters and to recalculate the likelihood, respectively, until the likelihood meets a given criterion.

8. A method of clustering information elements in items of information into groups of related information elements, the method comprising a processor carrying out the steps of:
providing count data representing the number of occurrences of elements in each item of information;
determining initial first model parameters representing a probability distribution for the groups, initial second model parameters representing for each element the probability for each group of that element being associated with that group, and initial third model parameters representing for each item the probability for each group of that item being associated with that group;
determining from prior information input by a user using a user input receiver prior probability data for at least some of the second model parameters;
calculating, for each item of information and for each information element of that item, the expected probability of that item and that element being associated with each group using the initial first, second and third model parameters and the determined prior probability data;
updating the first, second and third model parameters in accordance with calculated expected probabilities and the count data;
calculating a likelihood on the basis of the expected probabilities and the count data; and
causing the expected probability calculating, model parameter updating and likelihood calculating to be repeated, until the likelihood meets a given criterion.

9. A method according to claim 8, wherein the prior information specifies the allocation of information elements to groups.

10. A method according to claim 9, further comprising displaying on a display of the user input receiver a table having cells arranged in rows and columns with one of the columns and rows representing groups and the other representing information elements to enable input of prior information and associating an information element with a group when that information element is placed by the user in a cell in the row or column representing that group.

11. A method according to claim 9, comprising enabling a user to specify a relevance of an allocated information element to a group using the user input receiver.

12. A method according to any of claims, which further comprises enabling a user to input data indicating the overall relevance of prior information input by the user using the user input receiver.

13. A method according to claim 8, further comprising calculating expected probabilities of a given item and element being associated with each of the groups by, for each group, obtaining a numerator value group by multiplying the first model parameter, the second model parameter, the third model parameter and the prior probability data for that group, item and element, and then normalising by dividing by the sum of the numerators for each group.

14. A method of clustering information elements in items of information into groups of related information elements, the method comprising a processor carrying out the steps of:
providing count data representing the number of occurrences of elements in each item of information;
determining initial first model parameters representing a probability distribution for the groups, initial second model parameters representing for each element the probability for each group of that element being associated with that group, and initial third model parameters representing for each item the probability for each group of that item being associated with that group;
determining prior data from prior information input by a user using a user input receiver;
modifying the count data in accordance with the prior data to provide modified count data;
calculating, for each item of information and for each information element of that item, the expected probability of that item and that element being associated with each group using the first, second and third model parameters;
updating the first, second and third model parameters in accordance with the calculated expected probabilities and the modified count data;
calculating a likelihood on the basis of the expected probabilities and the modified count data; and
causing the expected probability calculating, model parameter updating and likelihood calculating to be repeated, until the likelihood meets a given criterion.

15. Calculating apparatus for information analysing apparatus for clustering information elements in items of information into groups of related information elements, the apparatus comprising:
a receiver for receiving count data representing the number of occurrences of elements in each item of information modified by prior information input by a user using the user input, first model parameters representing a probability distribution for the groups, second model parameters representing for each element the probability for each group of that element being associated with that group, third model parameters representing for each item the probability for each group of that item being associated with that group;
an expected probability calculator for receiving the first, second and third model parameters and for calculating, for each item of information and for each information element of that item, the expected probability of that item and that element being associated with each group using the first, second and third model parameters;
a model parameter updater for updating the first, second and third model parameters in accordance with the expected probabilities calculated by the expected probability calculator and the modified count data;
a likelihood calculator for calculating a likelihood on the basis of the expected probabilities and the modified count data; and
a controller for causing for causing the expected probability calculator, the model parameter updater and the likelihood calculator to recalculate the expected probabilities using updated model parameters, to update the model parameters and to recalculate the likelihood, respectively, until the likelihood meets a given criterion.

16. Apparatus according to claim 15, wherein the expected probability calculator is arranged to calculate the expected probabilities of a given item and element being associated with each of the groups by, for each group, obtaining a numerator value group by multiplying the first model parameter, the second model parameter and the third model parameter for that group, item and element, and then normalising by dividing by the sum of the numerators for each group.

17. Apparatus according to claim 15, wherein the model parameter updater is arranged to update the first model parameter for each group by multiplying the count data for each combination of information element and item of information by the corresponding expected probability, summing the resultant values for all items of information and all information elements and normalising by dividing by the sum of the count data for each element in each item.

18. Apparatus according to claim 15, wherein the model parameter updater is arranged to update the second model parameter for each group and information element combination by, for each item of information, obtaining a second model parameter numerator value by multiplying the count data for that element and item of information combination by the corresponding expected probability and summing the resultant values for all items of information, and then normalising by dividing by the sum of the second model parameter numerator values for all information elements.

19. Apparatus according to claim 15, wherein the model parameter updater is arranged to update the third model parameters for each group and item of information combination by, for each information element, obtaining a third model parameter numerator value by multiplying the count data for that information element and item of information combination by the corresponding expected probability and then summing the resultant values for all information elements, and then normalising by dividing by the sum of the third model parameter numerator values for all items of information.

20. Apparatus according to claim 15, wherein the likelihood calculator is arranged to calculate a likelihood value by summing the results of multiplying the count for each item of information and information element combination by the logarithm of the corresponding expected probability.

21. Apparatus according to claim 15, further comprising a matrix store having a first store configured to store a K element vector of first model parameters, a second store configured to store a N by K matrix of second model parameters and a third store configured to store an M by K matrix of third model parameters, where K is the number of groups, N is the number of items of information and M is the number of information elements, the initial model parameter determiner and the model parameter updater being arranged to write model parameter data to the first, second and third stores and the expected probability calculator being arranged to read model parameter data from the first, second and third stores.

22. Apparatus according to claim 15, comprising a word count store configured to store a N by X matrix of word counts where N is the number of items of information and X is the number of information elements, the model parameter updater and the likelihood calculator being arranged to read word counts from the word count store.

23. Information analysing apparatus for clustering information elements in items of information into groups of related information elements, the apparatus comprising:
a count data provider for providing count data representing the number of occurrences of elements in each item of information;
an initial model parameter determiner for determining a plurality of parameters;
a user input receiver for enabling a user to input prior information relating to the relationship between at least some of the groups and at least some of the elements;
a prior data determiner for determining from prior information input by a user using the user input receiver prior probability data;
an expected probability calculator for receiving the first, second and third model parameters and the prior probability data and for calculating, for each item of information and for each information element of that item, the expected probability of that item and that element being associated with each group using the plurality of parameters and the prior probability data determined by the prior data determiner;
a parameter updater for updating the plurality of parameters in accordance with the expected probabilities calculated by the expected probability calculator and the count data stored by the count data provider.

24. Apparatus according to claim 23, further comprising:
a likelihood calculator for calculating a likelihood on the basis of the expected probabilities and the count data stored by the count data provider; and
a controller for causing the expected probability calculator, the parameter updater and the likelihood calculator to recalculate the expected probabilities using the prior probability data and updated parameters, to update the parameters and to recalculate the likelihood, respectively, until the likelihood meets a given criterion.

25. Apparatus according to claim 23, wherein the plurality of parameters comprise first model parameters representing a probability distribution for the groups, second model parameters representing for each element the probability for each group of that element being associated with that group, and third model parameters representing for each item the probability for each group of that item being associated with that group.

26. A method of clustering information elements in items of information into groups of related information elements, the method comprising the steps of:
providing count data representing the number of occurrences of elements in each item of information;
determining a plurality of parameters;
receiving from a user prior information relating to the relationship between at least some of the groups and at least some of the elements;
determining prior probability data from prior information input by a user;
calculating, for each item of information and for each information element of that item, the expected probability of that item and that element being associated with each group using the plurality of parameters and the determined prior probability data;
updating the plurality of parameters in accordance with the calculated expected probabilities and the count data.

27. A method according to claim 26, further comprising:
calculating a likelihood on the basis of the expected probabilities and the count data; and
causing the expected probability calculating, the parameter updating and the likelihood calculating to be repeated until the likelihood meets a given criterion.

28. A method according to claim 26, wherein the plurality of parameters comprise first model parameters representing a probability distribution for the groups, second model parameters representing for each element the probability for each group of that element being associated with that group, and third model parameters representing for each item the probability for each group of that item being associated with that group.

29. Information analysing apparatus for clustering information elements in items of information into groups of related information elements, the apparatus comprising:
count data providing means for providing count data representing the number of occurrences of elements in each item of information;
initial model parameter determining means for determining a plurality of parameters;
user input means for enabling a user to input prior information relating to the relationship between at least some of the groups and at least some of the elements;
prior data determining means for determining from prior information input by a user using the user input means prior probability data;
expected probability calculating means for receiving the first, second and third model parameters and the prior probability data and for calculating, for each item of information and for each information element of that item, the expected probability of that item and that element being associated with each group using the plurality of parameters and the prior probability data determined by the prior data determining means;
parameter updating means for updating the plurality of parameters in accordance with the expected probabilities calculated by the expected probability calculating means and the count data stored by the count data providing means.

30. A signal comprising program instructions for programming a processor to carry out a method in accordance with claim 8.

31. A signal comprising program instructions for programming a processor to carry out a method in accordance with claim 26.

32. A storage medium comprising program instructions for programming processor to carry out a method in accordance with claim 8.

33. A storage medium comprising program instructions for programming a processor to carry out a method in accordance with claim 28.
